(19) United States
(12) Patent Application Publication
(10) Pub. No.: US 2024/0284426 A1
(43) Pub. Date: Aug. 22, 2024

(54) CARRIER SWITCHING METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Zhihua SHI, Dongguan (CN); Zhi ZHANG, Dongguan (CN)

(73) Assignee: GUANGDONG OPPO MOBILE TELECOMMUNICATIONS CORP., LTD., Dongguan (CN)

(21) Appl. No.: 18/651,490

(22) Filed: Apr. 30, 2024

Related U.S. Application Data
(63) Continuation of application No. PCT/CN2021/128565, filed on Nov. 4, 2021.

(51) Int. Cl. H04W 72/0453; H04W 72/231; H04W 72/51

(52) U.S. Cl. CPC H04W 72/0453; H04W 72/231; H04W 72/51

(57) ABSTRACT

A carrier switching method, a terminal device and a network device are provided. The method includes the following operations. A terminal device sends information on N carriers, N being an integer greater than or equal to 2. The terminal device determines M carriers on the basis of the obtained first switching information. At least one of the M carriers is different from any one of the N carriers, and M is an integer greater than or equal to 1. The terminal device sends information on the M carriers.

### CROSS-REFERENCE TO RELATED APPLICATION

This is a continuation application of International Patent Application No. PCT/CN2021/128565, filed on Nov. 4, 2021, the disclosure of which is hereby incorporated by reference in its entirety.

### BACKGROUND

A carrier which is suitable for a terminal device to communication may be different due to a factor such as a geographic position, a moving speed, a channel environment of the terminal device. Therefore, which carrier is used by the terminal device for information transmission is a problem that is always concerned in this field.

### SUMMARY

The embodiments of the disclosure relates to the technical field of communications, and in particular to a carrier switching method and a terminal device and a network device.

A first aspect of the embodiments of the disclosure provides a carrier switching method. The method includes the following operations.

A terminal device sends information on N carriers. N is an integer equal to or greater than 2.

The terminal device determines M carriers based on obtained first switching information, at least one of the M carriers is different from any one of the N carriers, and M is an integer equal to or greater than 1.

The terminal device sends information on the M carriers.

A second aspect of the embodiments of the disclosure provides a terminal device, and the terminal device includes a transceiver, a memory and a processor.

The memory stores a computer program executable on the processor.

The processor executes the program to: control the transceiver to send information on N carriers, N being an integer equal to or greater than 2; determine M carriers based on obtained first switching information, where at least one of the M carriers is different from any one of the N carriers, and M is an integer equal to or greater than 1; and control the transceiver to send information on the M carriers.

A third aspect of the embodiments of the disclosure provides a network device, and the network device includes a transceiver, a memory and a processor.

The memory stores a computer program executable on the processor.

The processor executes the program to: control the transceiver to receive, on N carriers, information sent by a terminal device, N being an integer equal to or greater than 2; control the transceiver to send first switching information to the terminal device, where the first switching information is used by the terminal device to determine M carriers, at least one of the M carriers is different from any one of the N carriers, and M is an integer equal to or greater than 1; and control the transceiver to receive, on the M carriers, information sent by the terminal device.

### BRIEF DESCRIPTION OF THE DRAWINGS

The drawings described here are intended to provide a further understanding of the disclosure, and constitute a part of the disclosure. Schematic embodiments of the disclosure and descriptions thereof are intended to explain the disclosure, and do not constitute an improper limitation to the disclosure.

FIG. 1 is a schematic diagram of an application scenario of an embodiment of the disclosure.

FIG. 2 is a schematic diagram of a configured or activated carrier and a carrier for carrying uplink transmission of a terminal device provided in an embodiment of the disclosure.

FIG. 3 is a schematic flowchart of a carrier switching method provided in an embodiment of the disclosure.

FIG. 4 is a schematic diagram of a method for dividing multiple carrier sets provided in an embodiment of the disclosure.

FIG. 5 is a schematic diagram of another method for dividing multiple carrier sets provided in an embodiment of the disclosure.

FIG. 6 is a schematic diagram of a carrier switching mode provided in an embodiment of the disclosure.

FIG. 7A is a schematic diagram of another carrier switching mode provided in an embodiment of the disclosure.

FIG. 7B is a schematic diagram of another carrier switching mode provided in an embodiment of the disclosure.

FIG. 8 is a schematic flowchart of switching carriers based on MAC signaling provided in an embodiment of the disclosure.

FIG. 9 is a schematic diagram of an effective time of MAC signaling provided in an embodiment of the disclosure.

FIG. 10 is a schematic flowchart of another carrier switching method provided in an embodiment of the disclosure.

FIG. 11 is a schematic diagram of a composition structure of a terminal device provided in an embodiment of the disclosure.

FIG. 12 is a schematic diagram of a composition structure of a network device provided in an embodiment of the disclosure.

FIG. 13 is a schematic structural diagram of a communication device provided in an embodiment of the disclosure.

FIG. 14 is a schematic structural diagram of a chip according to an embodiment of the disclosure.

### DETAILED DESCRIPTION

Technical solutions in the embodiments of the disclosure will be described below with reference to the drawings in the embodiments of the disclosure. It is apparent that the described embodiments are part of the embodiments of the disclosure, rather than all of the embodiments. Based on the embodiments in the disclosure, all other embodiments obtained by those of ordinary skill in the art without paying any creative work fall within the scope of protection of the disclosure.

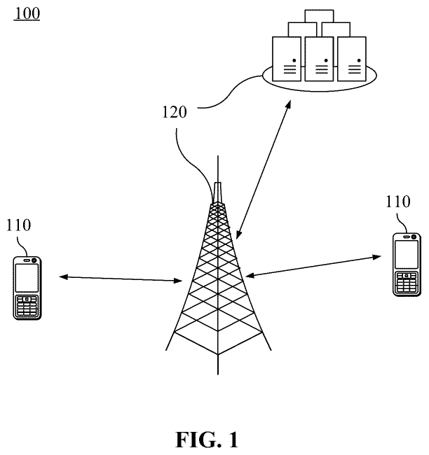

FIG. 1 exemplarily shows a base station, a core network device and two terminal devices. In some embodiments, the wireless communication system 100 may include multiple base station devices, and other numbers of terminal devices are within the coverage of each base station, which is not limited in the embodiments of the disclosure.

It should be noted that FIG. 1 only exemplifies a system to which the disclosure is applicable. Of course, the methods shown in the embodiments of the disclosure may also be applicable to other systems. Furthermore, terms “system” and “network” here are often used interchangeably in the disclosure. A term “and/or” here only indicates an association relationship describing associated objects, and indicates that there may be three relationships. For example, A and/or B may indicate three situations, that is, A exists alone, A and B exist simultaneously, and B exists alone. Furthermore, a character “/” here usually indicates that anterior and posterior associated objects are in a “or” relationship. It should also be understood that “indication” mentioned in the embodiments of the disclosure may be a direct indication, or may be an indirect indication, or may mean an association relationship. For example, A indicates B, which may mean that A directly indicates B, for example, B may be acquired through A; or, may mean that A indirectly indicates B, for example, A indicates C, and B may be acquired through C; or, may mean that there is an association relationship between A and B. It should also be understood that “correspond” mentioned in the embodiments of the disclosure may mean direct correspondences or indirect correspondences between two objects; or, may mean an association relationship between two objects; or, may be an indication relationship, or a configuration relationship, etc. It should also be understood that “predefined”, “agreed by a protocol”, “predetermined” or “predefined rule” mentioned in the embodiments of the disclosure may be implemented by storing in advance corresponding codes, tables or other modes available to indicate relevant information in devices (for example, including terminal devices and network devices), specific implementations thereof are not limited in the disclosure. For example, “predefined” may refer to defining in a protocol. It should also be understood that in the embodiments of the disclosure, the “protocol” may refer to a standard protocol in the communication field, and for example, may include a Long Term Evolution (LTE) protocol, a New Radio (NR) protocol, and relevant protocols applied to a future communication system, which are not limited in the disclosure.

In order to facilitate understanding the technical solutions of the embodiments of the disclosure, relevant technologies of the embodiments of the disclosure are described below. The following relevant technologies as optional solutions may be arbitrarily combined with the technical solutions of the embodiments of the disclosure, all of which fall within the scope of protection of the embodiments of the disclosure.

Due to a limit for design complexity of the terminal device, size of the terminal device, or the like, the terminal is assembled with at most two transmission links. However, the embodiments of the disclosure are not limited thereto. The number of transmission links of the terminal device may be an integer equal to or greater than 0 and less than or equal to 2, or may be an integer greater than 2. For example, the number of transmission links of the terminal device may be 0, 1, 2, 3, 4, 5, or 6, etc.

In the following embodiments, in a column which indicates the number of transmission links (carrier 1+carrier 2), aT+bT (a or b may be an integer equal to or greater than 0 and less than or equal to 2) indicates that the number of the transmission link of carrier 1 is a, and the number of transmission links of carrier 2 is b. For example, IT+IT indicates that the number of transmission links of carrier 1 is 1, and the number of transmission links of carrier 2 is 1. For another example, 0T+2T indicates that the number of transmission links of carrier 1 is 0, and the number of transmission links of carrier 2 is 2.

In the following embodiments, in a column which indicates a number of antenna ports for uplink transmission, cP+dP (c or d may be an integer equal to or greater than 0 and less than or equal to 2) indicates that the number of antenna ports for uplink transmission of carrier 1 is c, and the number of antenna ports for uplink transmission of carrier 2 is d. For example, 0P+2P indicates that the number of antenna ports for uplink transmission of carrier 1 is 0, and the number of antenna ports for uplink transmission of carrier 2 is 2. For another example, 0P+1P indicates that the number of antenna ports for uplink transmission of carrier 1 is 0, and the number of antenna ports for uplink transmission of carrier 2 is 1.

In the following embodiments, in the column which indicates the number of antenna ports for uplink transmission, cP+dP, eP+fP (e or f may be an integer equal to or greater than 0 and less than or equal to 2) indicates one of cP+dP and eP+fP.

In the following embodiments, in a column which indicates the number of transmission links (frequency band A+frequency band B), gT+hT (g or h may be an integer equal to or greater than 0 and less than or equal to 2) indicates that the number of transmission links of the carrier at frequency band A is g, and the number of transmission links of the carrier at frequency band B is h.

In the following embodiments, in a column which indicates a number of antenna ports for uplink transmission (frequency band A (carrier 1)+frequency band B (carrier 2+carrier 3)), iP+(jP+kP) indicates that the number of antenna ports for uplink transmission of carrier 1 at frequency band A is i, the number of antenna ports for uplink transmission of carrier 2 at frequency band B is j, and the number of antenna ports for uplink transmission of carrier 2 at frequency band B is k.

In NR Release 16 (Rel-16), a problem of switching of transmission links in an uplink carrier aggregation scenario is discussed. The uplink carrier aggregation scenario includes at most two frequency bands, i.e., frequency band A and frequency band B, each of the frequency bands has a carrier, that is, carrier aggregation of carrier 1 at frequency band A and carrier 2 at frequency band B.

The terminal device supports the following first switching mode or second switching mode.

Table 1 schematically shows uplink transmission modes of the first switching mode of the terminal device in situation 1 or situation 2.

TABLE 1

| | The number of | The number of antenna ports for |
|---|---|---|
| | transmission links | uplink transmission (carrier |
| | (carrier 1 + carrier 2) | 1 + carrier 2) |
| Situation 1 | 1T + 1T | 1P + 0P |
| Situation 2 | 0T + 2T | 0P + 2P, 0P + 1P |

In the first switching mode, the terminal device may switch between the uplink transmission mode of situation 1 and the uplink transmission mode of situation 2. For example, the uplink transmission mode of situation 1 is switched to the uplink transmission mode of situation 2, or the uplink transmission mode of situation 2 is switched to the uplink transmission mode of situation 1.

Table 2 schematically shows uplink transmission modes of the second switching mode of the terminal device in situation 1 or situation 2.

TABLE 2

| | The number of | The number of antenna ports for |
|---|---|---|
| | transmission links | uplink transmission (carrier |
| | (carrier 1 + carrier 2) | 1 + carrier 2) |
| Situation 1 | 1T + 1T | 1P + 0P, 1P + 1P, 0P + 1P |
| Situation 2 | 0T + 2T | 0P + 2P, 0P + 1P |

It may be seen from Table 1 and Table 2 that NR Rel-16 involves at most two frequency bands, and switching of transmission links in a case that each of the frequency bands has one carrier.

Switching of transmission links discussed in NR Release 17 (Rel-17) has two scenarios as follows.

A first scenario involves at most two frequency bands, i.e., frequency band A and frequency band B, each of the frequency bands has one carrier, that is, uplink carrier aggregation of carrier 1 at frequency band A and carrier 2 at frequency band B.

A second scenario involves at most two frequency bands, i.e., frequency band A and frequency band B, frequency band A has one carrier, and frequency band B has two continuous carriers, that is, uplink carrier aggregation of carrier 1 at frequency band A and carrier 2 and carrier 3 at frequency band B.

Table 3 schematically shows switching between uplink transmissions of two transmission links and uplink transmissions of two transmission links in the first scenario.

TABLE 3

| | The number of | The number of antenna ports for |
|---|---|---|
| | transmission links | uplink transmission (carrier |
| | (carrier 1 + carrier 2) | 1 + carrier 2) |
| Situation 1 | 1T + 1T | 1P + 0P, 1P + 1P, 0P + 1P |
| Situation 2 | 0T + 2T | 0P + 2P, 0P + 1P |
| Situation 3 | 2T + 0T | 2P + 0P, 1P + 0P |

Table 4 schematically shows switching between uplink transmission of one transmission link and uplink transmissions of two transmission links in the second scenario.

TABLE 4

| | The number of transmission | The number of antenna ports for uplink |
|---|---|---|
| | links (frequency band A + | transmission (frequency band A (carrier |
| | frequency band B) | 1) + frequency band B (carrier 2 + carrier 3)) |
| Situation 1 | 1T + 1T | 1P + (0P + 0P), 1P + (1P + 0P), 1P + (0P + 1P), |
| | | 1P + (1P + 1P), 0P + (1P + 0P), 0P + (0P + 1P), |
| | | 0P + (1P + 1P) |
| Situation 2 | 0T + 2T | 0P + (2P + 0P), 0P + (0P + 2P), 0P + (2P + 2P), |
| | | 0P + (1P + 0P), 0P + (0P + 1P), 0P + (1P + 1P), |
| | | 0P + (1P + 2P), 0P + (2P + 1P) |

Table 5 schematically shows switching between uplink transmissions of two transmission links and uplink transmissions of two transmission links in the second scenario.

TABLE 5

| | The number of | |
|---|---|---|
| | transmission | The number of antenna ports for |
| | links (frequency | uplink transmission (frequency band |
| | band A + | A (carrier 1) + frequency band B |
| | frequency band B) | (carrier 2 + carrier 3)) |
| Situation 1 | 1T + 1T | 1P + (0P + 0P), 1P + (1P + 0P), |
| | | 1P + (0P + 1P), 1P + (1P + 1P), |
| | | 0P + (1P + 0P), 0P + (0P + 1P), |
| | | 0P + (1P + 1P) |
| Situation 2 | 0T + 2T | 0P + (2P + 0P), 0P + (0P + 2P), |
| | | 0P + (2P + 2P), 0P + (1P + 0P), |
| | | 0P + (0P + 1P), 0P + (1P + 1P), |
| | | 0P + (1P + 2P), 0P + (2P + 1P) |
| Situation 3 | 2T + 0T | 2P + (0P + 0P), 1P + (0P + 0P) |

The number of carriers which may be configured or activated by the terminal device is up to two carriers, and the two carriers may belong to two frequency bands respectively. Uplink carrier aggregation capability of the terminal device is one or two carriers. The terminal device may send information on one or two carriers.

However, the above relevant technologies support switching of carriers at two frequency bands, and cannot support more flexible carrier switching between three or more carriers, or carrier switching between three or more frequency bands Therefore, the relevant technologies is difficult to meet requirements of throughput and/or data rate and/or load balancing or the like, and thus is difficult to meet transmission requirements of increasing uplink data volume.

In order to facilitate understanding the technical solutions of the embodiments of the disclosure, the technical solutions of the disclosure are described in detail below through specific embodiments. The above relevant technologies as optional solutions may be arbitrarily combined with the technical solutions of the embodiments of the disclosure, all of which fall within the scope of protection of the embodiments of the disclosure. The embodiments of the disclosure include at least a part of the following contents.

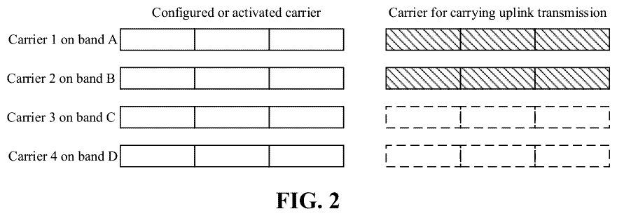

FIG. 2 is a schematic diagram of configured or activated carriers and carriers for carrying uplink transmission of a terminal device provided in an embodiment of the disclosure. As shown in FIG. 2, carriers configured or activated by the terminal device may include carrier 1 at frequency band A, carrier 2 at frequency band B, carrier 3 at frequency band C, and carrier 4 at frequency band D. The terminal device may select carrier 1 at frequency band A and carrier 2 at frequency band B as the carriers for carrying uplink transmission.

The transmission link in the embodiment of the disclosure may refer to a radio frequency (RF) link of the terminal device. In some embodiments, the terminal device may support one transmission link, two transmission links, three transmission links, or more than three transmission links, etc. The terminal device may transmit physical channels or information through the transmission link.

Any frequency band in the embodiment of the disclosure may refer to a frequency band divided in a protocol, such as a frequency band divided in a fourth generation (4G) or fifth generation (5G) protocol or other protocols (such as sixth generation (6G), etc.). Any frequency band may be an uplink frequency band, and a frequency band may correspond to a band index. Exemplarily, the band index may be n8, n20, n78, n79, n83, n260, etc. Any one of the frequency bands listed in the embodiment of the disclosure may be a Frequency Division Duplex (FDD) frequency band, a Time Division Duplex (TDD) frequency band or a Supplementary UpLink (SUL) frequency band.

The frequency band and an operating frequency band described in the embodiment of the disclosure may have the same meaning.

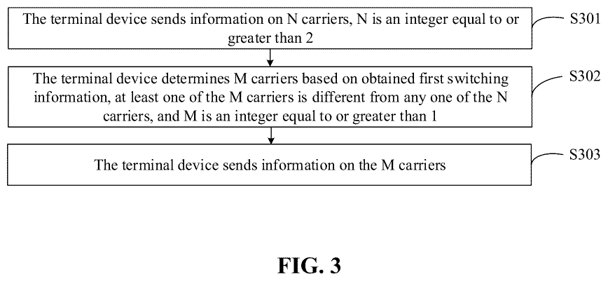

FIG. 3 is a schematic flowchart of a carrier switching method provided in an embodiment of the disclosure. As shown in FIG. 3, the method is applied to a terminal device, and the method includes the following operations S301 to S303.

At S301, the terminal device sends information on N carriers. N is an integer equal to or greater than 2.

In some embodiments, N may be 2, 3, 4 or the like. In some other embodiments, N may be 1.

The information in the embodiment of the disclosure may be uplink information or sidelink information. If the information is sent by the terminal device to a network device, the information is uplink information. If the information is sent from the terminal device to a target device, the information is sidelink information.

The uplink information in the embodiment of the disclosure may include uplink data information and/or Uplink Control Information (UCI). The UCI may include at least one of Hybrid Automatic Repeat reQuest (HARQ)-ACKnowledge (ACK), a Scheduling Request (SR), or a Channel State Information (CSI). In some implementations, HARQ-ACK may include an ACK and a Negative ACKnowledgment (NACK), or HARQ-ACK may include one of an ACK and a NACK.

The uplink information may be uplink data information carried by a Physical Uplink Shared Channel (PUSCH), or UCI carried by a Physical Uplink Control Channel (PUCCH), or a Sounding Reference Signal (SRS), or a Physical Random Access Channel (PRACH).

The sidelink information in the embodiment of the disclosure may include sidelink data information and/or sidelink control information.

Different carriers of the N carriers are located at different operating frequency bands. Alternatively, at least two of the N carriers are located at the same operating frequency band. In some embodiments, in a case that at least two carriers are located at the same frequency band, any two of the at least two carriers may be continuous or discontinuous.

In some embodiments, the N carriers may include a first carrier and a second carrier, and a frequency band where the first carrier is located is different from a frequency band where the second carrier is located. For example, the frequency band where the first carrier is located is frequency band A, and the frequency band where the second carrier is located is frequency band B. In some other embodiments, the N carriers may include a first carrier and a second carrier, and a frequency band where the first carrier is located is the same as a frequency band where the second carrier is located. For example, each of the frequency band where the first carrier is located and the frequency band where the second carrier is located is frequency band A or frequency band B. The first carrier and the second carrier may be continuous or discontinuous. In some embodiments, a continuous carrier may be a set of two or more carriers configured in a spectrum block, where there is no coexistence RF requirement based on uncoordinated operations within the spectrum block. Exemplarily, frequency band A may include a first frequency sub-band and a second frequency sub-band, a band range of the first frequency sub-band does not overlap with a band range of the second frequency sub-band, the frequency band where the first carrier is located is the first frequency sub-band, and the band where the second carrier is located is the second frequency sub-band. In some other embodiments, the N carriers may include a first carrier, a second carrier and a third carrier, and frequency bands where the first carrier, the second carrier and the third carrier are located are different from each other; or, the frequency band where the first carrier is located is the same as the frequency band where the second carrier is located, and the frequency band where the first carrier is located is different from the frequency band where the third carrier is located; or, the frequency bands where the first carrier, the second carrier and the third carrier are located respectively are the same with each other.

The terminal device may transmit information on at most T carriers, and T may be an integer equal to or greater than N. Exemplarily, T may be 2, that is, the terminal device may transmit information on at most two carriers (T is equal to 2 in this case), and the terminal device transmits information at the first carrier and the second carrier, so that the most available carriers of the terminal device may be fully used, thereby raising a rate of transmitting information by the terminal device and capacity of uplink transmission. In some embodiments, information sent by different carriers may be different, for example, information sent by the first carrier may be different from information sent by the second carrier. In some other embodiments, the terminal device may transmit information on at most three or more carriers (such that T is equal to or greater than 3), however, the terminal device may not use all available carriers, for example, the terminal device may transmit information at the first carrier and the second carrier, and does not transmit information at the third carrier. In some implementation scenarios, the number of carriers for sending information may be determined based on applications currently executed on the terminal device. For example, in a case that the terminal device is executing a live broadcast application, a high uplink rate is required since a live video is uploaded. Therefore, it may be determined that a large number of carriers are required for sending information. For another example, in a case that the terminal device is executing a game application, a low uplink rate is required. Therefore, it may be determined that a small number of carriers are required for sending information.

In some embodiments, before S301, that is, before the terminal device sends information on the N carriers, the terminal device may acquire third switching information. The third switching information may be obtained from the terminal device, or the third switching information may be information which is received by the terminal device from the network device or the target device. Therefore, the terminal device may determine, based on the third switching information, that the terminal device sends information on the N carriers among configured or activated more than N carriers. The terminal device, the network device or the target device may determine the third switching information based on at least one of a measurement result, channel quality, occupancy situation of time-frequency resources, uplink and downlink service requirements, or the like of a currently accessed cell measured by the terminal device. The network device or the target device may allocate the N carriers to the terminal device based on frequency bands supported by the terminal device. For example, during a random access procedure or after the random access procedure, the network device may send the third switching information to the terminal device, and the third switching information carries identifiers of the N carriers, and the terminal device may send information on the N carriers based on the identifiers of the N carriers. In some embodiments, before S301, the terminal device may acquire fourth switching information, and the fourth switching information indicates the number of transmission links corresponding to each of the N carriers, and the terminal device may send information on the transmission link corresponding to each of the N carriers. A mode of obtaining the fourth switching information may be the same as that of obtaining the third switching information. The third switching information and the fourth switching information may be contained in one signaling.

In some other embodiments, the terminal device may determine to send information on the N carriers according to a default rule. In some embodiments, a difference between center frequencies corresponding to any two carriers among N carrier frequencies corresponding to the N carriers may be greater than a preset value, and the terminal device may transmit information on a carrier having a large frequency difference. In other embodiments, a difference between center frequencies corresponding to any two of the carriers among N carrier frequencies corresponding to the N carriers may be less than a specific value, and the terminal device may transmit information on a carrier having a small frequency difference. In some embodiments, the terminal device may determine the N carriers after the random access procedure, and send information on the N carriers.

The N carriers may be determined based on a distance and/or quality of a communication link between the terminal device and the network device or between the terminal device and the target device. For example, in a case that the distance is greater than a preset distance and/or the quality of the communication link is lower than a quality threshold, the N carrier frequencies corresponding to the N carriers respectively are less than a preset frequency, and in a case that the distance is less than or equal to the preset distance and/or the quality of the communication link is equal to or greater than the quality threshold, the N carrier frequencies corresponding to the N carriers respectively are equal to or greater than the preset frequency.

In some embodiments, one carrier may correspond to one transmission link, that is, information sent by the terminal device on one carrier may be sent through one transmission link. In some other embodiments, one carrier may correspond to multiple transmission links, that is, the information sent by the terminal device on one carrier may be sent through multiple transmission links. In some other embodiments, multiple carriers may correspond to one transmission link, that is, information sent by the terminal device on multiple carriers may be sent through one transmission link.

In some embodiments, in a case that the terminal device may transmit information on at most T carriers, the terminal device may have at most T transmission links. In some other embodiments, the terminal device may have at most P transmission links, and P is equal to or greater than 1 and less than or equal to T, for example, P=T=2. The P transmission links may correspond to P antenna ports, that is, the transmission links may have one-to-one correspondences with the antenna ports. In some other embodiments, the transmission links may have one-to-multiple or multiple-to-one correspondences with the antenna ports. In some embodiments, one carrier may use one antenna port, or one carrier may use multiple antenna ports (for example, 2, 3 or 4), or one antenna port may be multiplexed by different carriers.

In some embodiments, the N carriers may have one-to-one correspondences with N transmission links or transmitters or transmission channels. One transmission link or transmitter or transmit channel may correspond to one RF device. Carrier switching may be expressed as switching of transmission links or switching of transmission channels or switching of transmitters or switching of RF devices.

At S302, the terminal device determines M carriers based on obtained first switching information, at least one of the M carriers is different from any one of the N carriers, and M is an integer equal to or greater than 1. M may be equal to or different from N.

In some embodiments, the M carriers are obtained by switching at least one of the N carriers to R carriers. That is, at least one of the N carriers is changed to R carriers. The R carriers are not contained in the N carriers, the R carriers are the M carriers, or the R carriers and a carrier of the N carriers which is not switched constitute the M carriers. For example, in a case that all of the N carriers are switched to R carriers, the R carriers are the M carriers. In a case that a part of the N carriers are switched to R carriers, the R carriers and a carrier of the N carriers which is not switched constitute the M carriers.

In some embodiments, the terminal device may receive the first switching information sent by the network device or the target device. In some other embodiments, the terminal device may acquire the first switching information from the terminal device.

The first switching information may indicate that at least one of the N carriers is switched to the R carriers, or the first switching information may indicate that the N carriers are switched to the M carriers.

The network device or the target device may measure a distance and/or quality of a communication link between the terminal device and the network device or the target device at a preset time interval, and determine to send the first switching information to the terminal device based on the distance and/or the quality of the communication link. Alternatively, the terminal device may measure a distance and/or quality of a communication link between the terminal device and the network device or the target device at a preset time interval, and determine the first switching information based on the distance and/or the quality of the communication link.

In some embodiments, the first switching information may include an identifier of at least one of the N carriers and identifiers of the R carriers. In some other embodiments, the first switching information may include identifiers of the M carriers.

The carrier identifier in the embodiment of the disclosure may be a carrier index. In some embodiments, if different carriers correspond to different frequency bands, the carrier index may also be a frequency band index.

The number of at least one of the N carriers may be the same as or different from the number of the R carriers.

At S303, the terminal device sends information on the M carriers.

In some embodiments, the information sent on the M carriers may be different from the information sent on the N carriers.

In some embodiments, any one of the M carriers may be different from any one of the N carriers. In some other embodiments, at least one of the M carriers may be the same as at least one of the N carriers. Both the M carriers and the N carriers belong to carriers configured or activated by the network device or the target device or the terminal device.

The M carriers may include one or more carriers. Each of the M carriers may correspond to one or more transmission links, that is, information sent by the terminal device on each of the M carriers may be sent through one or more transmission links. Alternatively, information sent on part or all of the M carriers may be sent through one transmission link.

In some embodiments, the terminal device may determine a setting slot (i.e., an effective slot described below), transmit information at the N carriers before the setting slot, and transmit information at the M carriers at the setting slot and after the setting slot. An effective time length may be spaced between a moment when the first switching information is received and the setting slot. In some embodiments, within a time period corresponding to the effective time length, the terminal device may send information at the N carriers, or the terminal device may not send information.

In the embodiments of the disclosure, in a case that the terminal device sends information on N carriers, the terminal device may determine M carriers according to obtained first switching information, and send information on the M carriers, so that the terminal device may send information on the M carriers different from the N carriers, which improves controllability of sending information by the terminal device. Therefore, the terminal device may flexibly select an appropriate carrier for sending information. Furthermore, since at least one of the M carriers is different from any one of the N carriers, the terminal device may send information on other carriers except the N carriers, which improves a selection range of carriers for sending information.

In some embodiments, an operating frequency band where any carrier from at least one of the M carriers is located is different from an operating frequency band where each of the N carriers is located.

Alternatively, operating frequency bands where one or more carriers from the at least one of the M carriers are located are the same as operating frequency bands where one or more carriers of the N carriers are located respectively.

For example, if the N carriers include the first carrier or the second carrier, and the M carriers include the third carrier, the frequency band of the first carrier or the second carrier may be the same as or different from that of the third carrier. For another example, if the N carriers include the first carrier and the second carrier, and the M carriers include the third carrier and a fourth carrier, the frequency band of the first carrier may be different from that of any one of the third carrier and the fourth carrier, or, the frequency band of the first carrier may be the same as that of at least one of the third carrier or the fourth carrier; the frequency band of the second carrier may be different from that of any one of the third carrier and the fourth carrier, or, the frequency band of the second carrier may be the same as that of at least one of the third carrier or the fourth carrier.

In some embodiments, the first switching information is sent by a network device, the first switching information is carried in Radio Resource Control (RRC) signaling. In some other embodiments, the first switching information is carried in Medium Access Control (MAC) signaling. In some other embodiments, the first switching information is carried in Downlink Control Information (DCI). The MAC signaling may include a MAC Control Element (CE).

A long time is required for RRC layer signaling from a time that the network device determines the signaling to a time that the signaling goes into effect the terminal device, and configuration of the RRC layer signaling may interrupt uplink data transmission of the terminal device, which greatly decreases uplink throughput. If the first switching information is carried in the MAC signaling, the MAC CE may shorten a service interruption time caused by carrier switching.

In some embodiments, the operation that the terminal device sends information on the N carriers may include the following operations. The terminal device sends information on a transmission link corresponding to each of the N carriers. One carrier may correspond to one or more transmission links.

The operation that the terminal device sends information on the M carriers may include the following operations. The terminal device sends information on a transmission link corresponding to each of the M carriers.

In a case that at least one of the N carriers is switched to R carriers, a transmission link corresponding to at least one of the N carriers is switched to transmission links corresponding to the R carriers.

In some embodiments, the number of transmission links corresponding to at least one of the N carriers may be the same as or different from the number of transmission links corresponding to the R carriers.

The number of all transmission links corresponding to the N carriers may be less than or equal to a maximum number of transmission links configured by the terminal device. The number of all transmission links corresponding to the M carriers may be less than or equal to the maximum number of transmission links configured by the terminal device.

In some embodiments, at least one of the N carriers is switched to R carriers, the R carriers are not contained in the N carriers, the R carriers are the M carriers, or the R carriers and a carrier of the N carriers which is not switched constitute the M carriers.

The carrier switching method further includes the following operations. The terminal device obtains second switching information, the second switching information includes or is configured to indicate at least one of: a total number of transmission links corresponding to the R carriers; the number of transmission links corresponding to each of the R carriers; a total number of transmission links corresponding to the M carriers; the number of transmission links corresponding to each of the M carriers; a total number of transmission links corresponding to at least one of the N carriers; or the number of transmission links corresponding to each of the at least one of the N carriers.

For example, the terminal device sends information on the first carrier and the second carrier, and the first switching information indicates switching the first carrier to the third carrier. For example, the N carriers include the first carrier and the second carrier, and the M carriers include the second carrier and the third carrier. In this way, the second switching information may indicate at least one of: the number of transmission links corresponding to the first carrier, the number of transmission links corresponding to the third carrier, or a total number of transmission links corresponding to the second carrier and the third carrier. For another example, the terminal device sends information on the first carrier and the second carrier, and the first switching information indicates switching the second carrier to the fourth carrier. For example, the N carriers include the first carrier and the second carrier, and the M carriers include the first carrier and the fourth carrier. In this way, the second switching information may indicate at least one of: the number of transmission links corresponding to the second carrier, the number of transmission links corresponding to the fourth carrier, or a total number of transmission links corresponding to the first carrier and the fourth carrier. For another example, the terminal device sends information on the first carrier and the second carrier, and the first switching information indicates switching the first carrier to the third carrier and switching the second carrier to the fourth carrier. For example, the N carriers include the first carrier and the second carrier, and the M carriers include the third carrier and the fourth carrier. In this way, the second switching information may indicate at least one of: the number of transmission links corresponding to the first carrier, the number of transmission links corresponding to the third carrier, the number of transmission links corresponding to the second carrier, the number of transmission links corresponding to the fourth carrier, or a total number of transmission links corresponding to the third carrier and the fourth carrier.

The first switching information and the second switching information may be configured in one signaling or in different signaling.

In some embodiments, the N carriers belong to a first carrier set, the M carriers belong to a second carrier set, and the first switching information indicates switching the first carrier set to the second carrier set.

Carriers included in the first carrier set are at least partially different from carriers included in the second carrier set.

The number of carriers included in the first carrier set is the same as or different from the number of carriers included in the second carrier set. For example, the first carrier set may include carrier 1 and carrier 2, and the second carrier set may include carrier 1, or carrier 2 or carrier 3. For another example, the first carrier set may include carrier 1 and carrier 2, and the second carrier set may include carrier 3 and carrier 4. For another example, the first carrier set may include carrier 1 and carrier 2, and the second carrier set may include carrier 3 and carrier 2.

The network device and the terminal device may be configured with the same multiple carrier sets. Therefore, switching of carrier sets is indicated by the network device, and the terminal device implements carrier switching.

In some embodiments, a carrier index of any carrier in the first carrier set and/or an index of an operating frequency band to which any carrier in the first carrier set belongs is greater than a carrier index of any carrier in the second carrier set and/or an index of an operating frequency band to which any carrier in the second carrier set belongs.

In some other embodiments, the carrier index of any carrier in the first carrier set and/or the index of the operating frequency band to which any carrier in the first carrier set belongs is less than the carrier index of any carrier in the second carrier set and/or the index of the operating frequency band to which any carrier in the second carrier set belongs.

In this way, carriers included in different carrier sets do not overlap with each other. Center frequencies corresponding to carriers in multiple carrier sets configured by the network device and the terminal device may be ranked in a descending order or an ascending order. For example, in a case that one carrier set includes the first carrier and the second carrier, another carrier set does not include any one of the first carrier and the second carrier.

In some embodiments, carriers in the first carrier set are at least partially the same as carriers in the second carrier set.

For example, the first carrier set may include the first carrier and the second carrier, and the second carrier set may include the third carrier and the second carrier. For another example, the first carrier set may include the first carrier and the second carrier, and the second carrier set may include the third carrier.

In some other embodiments, any one of the carriers in the first carrier set is different from each of the carriers in the second carrier set.

The network device may configure or activate T carriers for the terminal device, or the terminal device may configure or activate T carriers, the T carriers belong to Q frequency bands, any two of the Q frequency bands are different, that is, frequency ranges corresponding to different frequency bands do not overlap with each other, and Q may be less than or equal to T. A maximum carrier aggregation capability of the terminal device may be carrier aggregation of the N carriers, and N may be less than or equal to T. The T carriers may be NR-dedicated carriers and/or SUL carriers, or a part of the T carriers are NR-dedicated carriers, and the other part of the T carriers are LTE-dedicated carriers.

In a case that the terminal device is a mobile phone, the most common design is to assemble at most two RF devices with the mobile phone, and the RF devices are associated with transmission links, that is, information may be sent through at most two transmission links. In current protocols, only two frequency bands with different center frequencies are configured to the terminal device, one of the frequency bands includes one carrier, and another frequency band includes at most two carriers, which may limit uplink resources which may be used by the terminal device. In order to increase uplink throughput and uplink capacity, the network device in the embodiment of the disclosure may configure more than two bands to the terminal device, and the terminal device may switch frequency bands for sending uplink transmission among more than two bands, and send information on two of the frequency bands.

A method for dividing multiple carrier sets is described below.

In some embodiments, N carriers among the configured or activated T carriers may be classified into a group to obtain multiple carrier sets. The T carriers may be grouped according to a descending order or an ascending order of indexes of the carriers and/or indexed of the carriers.

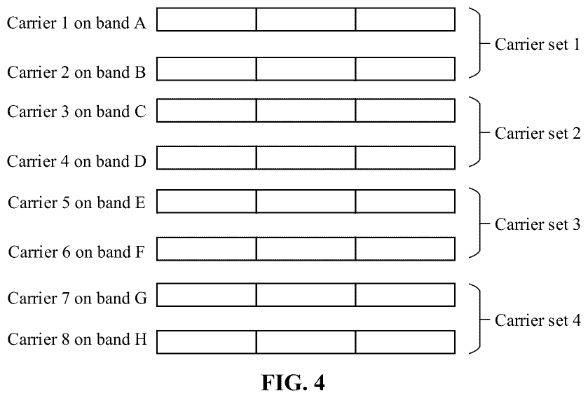

FIG. 4 is a schematic diagram of a method for dividing multiple carrier sets provided in an embodiment of the disclosure. As shown in FIG. 4, M=8, N=2, and different carriers of T carriers belong to different frequency bands, that is, Q=8. The eight frequency bands are band A to band H respectively, and each of the eight frequency bands includes one carrier, and there are eight carriers in total, which are carrier 1 to carrier 8 respectively. Center frequencies of frequency band A to frequency band H may increase or decrease sequentially, or frequencies of the eight carriers may increase or decrease sequentially.

During implementation, carrier sets may be divided in a fixed manner, and every two of the eight carriers may be classified into one carrier set. For example, carrier 1 and carrier 2 are classified into carrier set 1, carrier 3 and carrier 4 are classified into carrier set 2, carrier 5 and carrier 6 are classified into carrier set 3, and carrier 7 and carrier 8 are classified into carrier set 4.

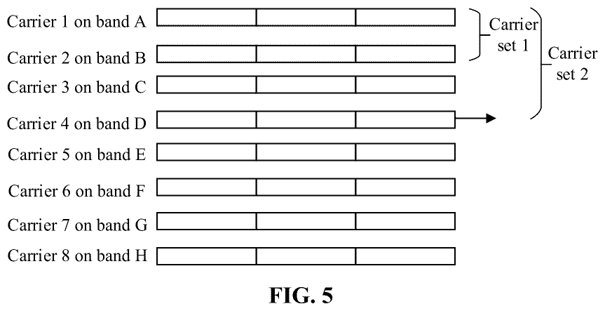

FIG. 5 is a schematic diagram of another method for dividing multiple carrier sets provided in an embodiment of the disclosure. As shown in FIG. 4, M=8, N=2, and different carriers of T carriers belong to different frequency bands, that is, Q=8. The eight frequency bands are frequency band A to frequency band H respectively, and the eight frequency bands correspond to eight carriers respectively, which are carrier 1 to carrier 8 respectively. Center frequencies of frequency band A to frequency band H may increase or decrease sequentially, or may be ranked in other ordering modes.

During implementation, carrier sets may be divided in a dynamic manner, and the network device or the terminal device may send information through dynamically switched carrier sets according to at least one of channel quality, occupancy situation of time-frequency resources, uplink and downlink service requirements, or the like. For example, carrier set 1 may include carrier 1 and carrier 2, and carrier set 2 may include carrier 1 and carrier 4. For example, the network device dynamically switches a carrier used by the terminal device to send information, according to at least one of channel quality of each channel or each carrier, a Reference Signal Receiving Power (RSRP), path loss, time-frequency resources occupancy situation, uplink and downlink service requirements or the like. For another example, the terminal device autonomously switches a carrier for sending information, according to at least one of measurement of channel quality of each channel or each carrier, a RSRP, path loss, time-frequency resources occupancy situation, uplink and downlink service requirements or the like. In some embodiments, N is 2, N is 2, and the N carriers include a first carrier and a second carrier; the first switching information indicates one of switching the first carrier to a third carrier, switching the second carrier to a fourth carrier, or switching the first carrier to the third carrier and switching the second carrier to the fourth carrier.

The embodiment of the disclosure is not limited thereto. In some embodiments, the first switching information may also indicate at least one of switching the first carrier and the second carrier to the third carrier or the fourth carrier, switching the first carrier to the third carrier and a fifth carrier, switching the second carrier to the fourth carrier and the fifth carrier, switching the first carrier and the second carrier to the third carrier, the fourth carrier and the fifth carrier, or the like.

The terminal device reports capability of supporting switching of a transmission link in a specific frequency band combination, and supports switching of at most two transmission links.

Contents of the first switching information may include at least one of the following contents: an index of the first carrier, an index of the second carrier, an index of the third carrier, an index of the fourth carrier, an index of the first carrier set, or an index of the second carrier set.

The terminal device determines M carriers according to the first switching information, and sends information through the M carriers.

In some embodiments, the first switching information may include a carrier index of each of the M carriers. In some other embodiments, the first switching information may include a carrier index of at least one of the N carriers and carrier indices of the R carriers.

For example, the carrier index of at least one of the N carriers or carrier indices of the N carriers may include a first carrier index 1 and a second carrier index 2. The carrier indices of the R carriers or carrier indices of the M carriers may include a third carrier index 3 and a fourth carrier index 4. For another example, the carrier index of at least one of the N carriers may include the second carrier index 2, and the carrier indices of the R carriers may include the fourth carrier index 4. For another example, the carrier index of at least one of the N carriers may include the first carrier index 1, and the carrier indices of the R carriers may include the fourth carrier index 3.

Exemplarily, the first switching information may include contents as shown in any one of Table 6a, Table 7a, Table 8a and Table 9a, or the first switching information may include contents as shown in any one of Table 6b, Table 7b, Table 8b and Table 9b. In Table 6a, Table 6b, Table 9a and Table 9b, indices of the N carriers may include the first carrier index 1 and the second carrier index 2, and indices of the M carriers include the third carrier index 3 and the fourth carrier index 4. In Table 7a and Table 7b, the indices of the N carriers may include the first carrier index 1 and the second carrier index 2, and the indices of the M carriers include the first carrier index 1 and the fourth carrier index 4. In Table 8a and Table 8b, the indices of the N carriers may include the first carrier index 1 and the second carrier index 2, and the indices of the M carriers include the second carrier index 2 and the third carrier index 3.

TABLE 6a

| carrier before switching | carrier after switching |
|---|---|
| first carrier index 1 | third carrier index 3 |
| second carrier index 2 | fourth carrier index 4 |

TABLE 6b

| | | duration of carrier |
|---|---|---|
| carrier before switching | carrier after switching | switching |
| first carrier index 1 | third carrier index 3 | first duration |
| second carrier index 2 | fourth carrier index 4 | second duration |

TABLE 7a

| carrier before switching | carrier after switching |
|---|---|
| second carrier index 2 | fourth carrier index 4 |

TABLE 7b

| | | duration of carrier |
|---|---|---|
| carrier before switching | carrier after switching | switching |
| second carrier index 2 | fourth carrier index 4 | second duration |

TABLE 8a

| carrier before switching | carrier after switching |
|---|---|
| first carrier index 1 | third carrier index 3 |

TABLE 8b

| | | duration of carrier |
|---|---|---|
| carrier before switching | carrier after switching | switching |
| first carrier index 1 | third carrier index 3 | first duration |

TABLE 9a
carrier after switching

third carrier index 3
fourth carrier index 4

TABLE 9b

| carrier after switching | duration of carrier switching |
|---|---|
| third carrier index 3 | first duration |
| fourth carrier index 4 | second duration |

In some embodiments, as shown in at least one of Table 6b, Table 7b, Table 8b or Table 9b, the first switching information may also indicate duration of carrier switching. Exemplarily, the first switching information may indicate duration of each of the M carriers, and durations of the M carriers may be the same with each other, or durations of different carriers may be different from each other.

For example, the first switching information indicates switching from the first carrier to the third carrier, and after the first switching information goes into effect, the terminal device sends information through the third carrier within the first duration, and the terminal device sends information on the first carrier after the first duration elapses.

For example, the first switching information indicates switching from the second carrier to the fourth carrier, and after the first switching information goes into effect, the terminal device sends information through the fourth carrier within the second duration, and the terminal device sends information on the second carrier after the second duration elapses.

For example, in a case that the first switching information indicates switching from the first carrier to the third carrier and switching from the second carrier to the fourth carrier, and after the first switching information goes into effect, the terminal device sends information on the third carrier and the fourth carrier within a larger one of the first duration and the second duration, and the terminal device sends information on the first carrier and the second carrier after the larger one of the first duration and the second duration elapses.

For example, in a case that the first switching information indicates switching from the first carrier to the third carrier and switching from the second carrier to the fourth carrier, and after the first switching information goes into effect, the terminal device may switch the third carrier to the first carrier after the first duration elapses in a case that the first duration is less than the second duration. In this way, the terminal device sends information on the first carrier and the fourth carrier after the first duration elapses, and the terminal device may switch the fourth carrier to the second carrier after the second duration elapses, so that the terminal device sends information on the first carrier and the fourth carrier after the second duration elapses.

In a case that the first switching information goes into effect, the terminal device may start a timer, a time length of which is the first duration or the second duration, or start two timers, time lengths of which are the first duration and the second duration respectively.

In some embodiments, carrier indices included in the first switching information may be marked by a bit map. For example, the first switching information may include 2 bits, the first bit may correspond to the first carrier or the first bit may be the carrier index of the first carrier, and the second bit may correspond to the second carrier or the second bit may be the carrier index of the second carrier.

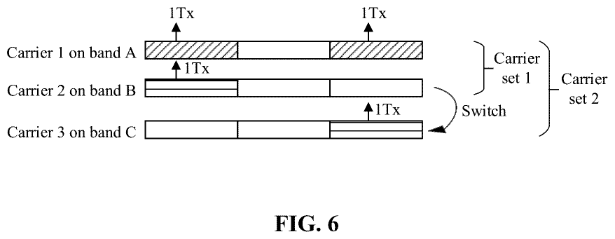

FIG. 6 is a schematic diagram of a carrier switching mode provided in an embodiment of the disclosure. As shown in FIG. 6, the terminal device sends information by a transmission link corresponding to carrier 1 at frequency band A and a transmission link corresponding to carrier 2 at frequency band B. After carrier switching, the terminal device sends information by a transmission link corresponding to carrier 1 at frequency band A and a transmission link corresponding to carrier 3 at frequency band C. The carrier 1 at frequency band A and the carrier 2 at frequency band B are included in carrier set 1, and the carrier 1 at frequency band A and carrier 3 at frequency band C are included in carrier set 2.

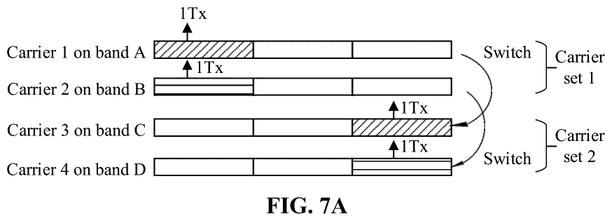

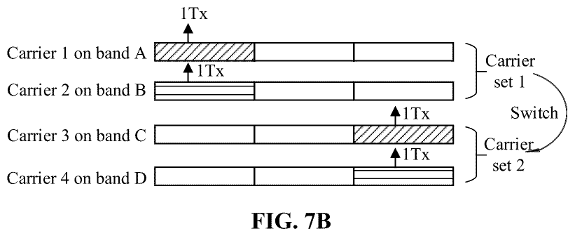

FIG. 7A is a schematic diagram of another carrier switching mode provided in an embodiment of the disclosure. As shown in FIG. 7A, the terminal device sends information by a transmission link corresponding to carrier 1 at frequency band A and a transmission link corresponding to carrier 2 at frequency band B. After carrier switching is performed by the carrier switching mode, the terminal device sends information by a transmission link corresponding to carrier 3 at frequency band C and a transmission link corresponding to carrier 4 at frequency band D. The carrier 1 at frequency band A and carrier 2 at frequency band B are included in carrier set 1, and carrier 3 at frequency band C and carrier 4 at frequency band D are included in carrier set 2.

FIG. 7B is a schematic diagram of yet another carrier switching mode provided in an embodiment of the disclosure. As shown in FIG. 7B, a difference of FIG. 7B from FIG. 7A lies in that a carrier switching mode is used to switch carriers in FIG. 7A, and a carrier set switching mode is used to switch carriers in FIG. 7B. The terminal device sends information by a transmission link corresponding to carrier 1 at frequency band A and a transmission link corresponding to carrier 2 at frequency band B. After carrier switching is performed by the carrier set switching mode, the terminal device sends information by a transmission link corresponding to carrier 3 at frequency band C and a transmission link corresponding to carrier 4 at frequency band D.

The carrier set switching mode is described below.

The terminal device reports capability of supporting switching of transmission links in a specific frequency band combination, and supports switching of at most two transmission links. Taking FIG. 7B as an example, the first carrier (carrier 1) and the second carrier (carrier 2) belong to the first carrier set (carrier set 1), the first switching information may be carried in RRC signaling, or the first switching information may be carried in MAC signaling, or the first switching information may be carried in DCI. The network device transmits information about division of carrier sets to the terminal device through RRC signaling. The network device may indicate switching the first carrier set to the second carrier set (carrier set 2), carrier set 2 includes the third carrier (carrier 3) and the fourth carrier (carrier 4), the first switching information may include at least one of an index of the first carrier set, or an index of the second carrier set.

The terminal device may determine the second carrier set according to the first switching information, and send information on carriers included in the second carrier set. The information may include at least one of uplink data information carried by a PUSCH, UCI carried by a PUCCH, an SRS carried by a PUCCH, or PRACH.

Exemplarily, the first switching information may include contents as shown in any one of Table 10a and Table 11a, or the first switching information may include contents as shown in any one of Table 10b and Table 11b. In Table 10a and Table 10b, the first switching information includes not only a carrier set before switching, but also a carrier set after switching. In Table 11a and Table 11b, the first switching information includes only a carrier set after switching.

TABLE 10a

| Carrier set | Index |
|---|---|
| carrier set before switching | index 1 |
| carrier set after switching | index 2 |

TABLE 10b

| Carrier set | Index |
|---|---|
| carrier set before switching | index 1 |
| carrier set after switching | index 2 |
| duration of carrier set switching | third duration |

TABLE 11a

| Carrier set | Index |
|---|---|
| carrier set after switching | index 2 |

TABLE 11b

| | | Duration of carrier set |
|---|---|---|
| Carrier set | Index | switching |
| carrier set after switching | index 2 | third duration |

In some embodiments, as shown in Table 10b and/or Table 11b, the first switching information may also indicate duration of carrier set switching. Exemplarily, the first switching information may indicate that a duration of the second carrier set after switching is a third duration.

For example, the first switching information indicates switching from the first carrier set to the second carrier set (switching from index 1 to index 2), and after the first switching information goes into effect, the terminal device sends information through the second carrier set within the third duration, and the terminal device sends information on the first carrier set after the third duration elapses.

When the first switching information goes into effect, the terminal device may start a timer, a time length of which is the third duration, and switch the second carrier set to the first carrier set in a case that the timer expires.

In some embodiments, the carrier switching method further includes at least one of: determining the number of transmission links corresponding to the third carrier; or determining the number of transmission links corresponding to the fourth carrier.

In some implementations, upon receiving the first switching information, the terminal device may determine the number of transmission links corresponding to the third carrier and/or the number of transmission links corresponding to the fourth carrier by a predefined rule. For example, the terminal device may determine the number of transmission links of each of the R carriers or determine a number of transmission links of each of the M carrier, for example, the number of transmission links corresponding to the third carrier and/or the number of transmission links corresponding to the fourth carrier. according to at least one of a total number of the N carriers, a transmission link corresponding to each of the N carriers, the number of at least one of the N carriers, a transmission link of each of the at least one of the N carriers, a total number of the M carriers, or the number of the R carriers.

In some other embodiments, the terminal device may determine the number of transmission links of each of the M carriers, or the number of transmission links of each of the R carriers through the second switching information.

In some embodiments, one transmission link corresponding to one carrier is switched to another carrier. For example, before switching, the number of transmission links corresponding to carrier 1 is 1, and the number of transmission links corresponding to carrier 2 is 1. After switching, carrier 1 is switched to carrier 3, and the number of transmission links corresponding to carrier 3 is 1.

Table 12 schematically shows transmission link information before and after carrier switching. In Table 12, transmission link information 1Tx indicates that the number of transmission links of the third carrier is 1.

TABLE 12

| | | Transmission link |
|---|---|---|
| Carrier before switching | Carrier after switching | information |
| first carrier index 1 | third carrier index 3 | 1Tx |

In some other embodiments, a total of two transmission links corresponding to two carriers are switched to another carrier. For example, before switching, the number of transmission links of carrier 1 is 1, and the number of transmission links of carrier 2 is 1. After switching, carrier 1 is switched to carrier 3, and the number of transmission links of carrier 3 is 2.

Table 13 schematically shows transmission link information before and after carrier switching. In Table 13, transmission link information 2Tx indicates that the number of transmission links of the third carrier is 2.

TABLE 13

| | | Transmission link |
|---|---|---|
| Carrier before switching | Carrier after switching | information |
| first carrier index 1 | third carrier index 3 | 2Tx |

In some other embodiments, a total of two transmission links corresponding to two carriers are switched to two transmission links corresponding to another two carriers. For example, before switching, a transmission link of carrier 1 is 1Tx, and a transmission link of carrier 2 is 1Tx. After switching, carrier 1 is switched to carrier 3, and carrier 2 is switched to carrier 4, a transmission link of carrier 3 is 1Tx, and a transmission link of carrier 4 is 1Tx.

Table 14 schematically shows transmission link information before and after carrier switching. In Table 14, transmission link information 1Tx indicates that the number of transmission links of the third carrier is 1 or the number of transmission links of the fourth carrier is 1.

TABLE 14

| | | Transmission link |
|---|---|---|
| Carrier before switching | Carrier after switching | information |
| first carrier index 1 | third carrier index 3 | 1Tx |
| second carrier index 2 | fourth carrier index 4 | 1Tx |

In some embodiments, the number of transmission links corresponding to the third carrier is the same as the number of transmission links corresponding to the first carrier. In some other embodiments, the number of transmission links corresponding to the fourth carrier is the same as the number of transmission links corresponding to the second carrier.

In some embodiments, the third carrier is associated with a first frequency band combination, the number of transmission links corresponding to the third carrier is the same as the number of transmission links supported by the terminal device corresponding to the first frequency band combination.

In some other embodiments, the fourth carrier is associated with a second frequency band combination, the number of transmission links corresponding to the fourth carrier is the same as the number of transmission links supported by the terminal device corresponding to the second frequency band combination.

The first frequency band combination and/or the second frequency band combination may include one or more frequency bands. In some embodiments, the first band combination may include the third carrier, or include the third carrier and a first specific carrier, and the first specific carrier may include the second carrier and/or a sixth carrier, or the like. For example, in a case that the first frequency band combination includes the second carrier and the third carrier, the terminal device may determine the number of transmission links supported by the terminal device corresponding to the second carrier and the third carrier. In some other embodiments, the second frequency band combination may include the fourth carrier, or include the fourth carrier and a second specific carrier, and the second specific carrier may include the first carrier and/or a seventh carrier, or the like. For example, in a case that the second frequency band combination includes the first carrier and the fourth carrier, the terminal device may determine the number of transmission links supported by the terminal device corresponding to the first carrier and the fourth carrier.

In some embodiments, in a case that the first carrier is switched to the third carrier, the number of transmission links corresponding to the third carrier is 1 or 2.

In some other embodiments, in a case that the second carrier is switched to the fourth carrier, the number of transmission links corresponding to the fourth carrier is 1 or 2.

In some other embodiments, in a case that the first carrier is switched to the third carrier and the second carrier is switched to the fourth carrier, each of the number of transmission links corresponding to the third carrier and the number of transmission links corresponding to the fourth carrier is 1.

In some embodiments, the number of transmission links corresponding to the third carrier and/or the number of transmission links corresponding to the fourth carrier is determined by the terminal device based on configuration information of the terminal device.

In some other embodiments, the number of transmission links corresponding to the third carrier and/or the number of transmission links corresponding to the fourth carrier is determined by the terminal device based on second switching information received from a network device.

In some embodiments, the carrier switching method further includes the following operations. The terminal device sends first capability information.

The first capability information indicates that the terminal device supports switching of a first number of carriers; and/or that the terminal device supports switching of a second number of transmission links.

The situation that the terminal device supports switching of the first number of carriers may include that the terminal device supports switching of the first number of carriers on a specific frequency band combination. The situation that the terminal device supports switching of the second number of transmission links may include that the terminal device supports switching of the second number of transmission links on a specific frequency band combination. Different frequency band combinations may correspond to the same first number or different first numbers, and different band combinations may correspond to the same second number or different second numbers.

The terminal device may send the first capability information to the network device or the target device. In some implementations, the terminal device may send the first capability information to the network device during a random access procedure. In some other implementations, the terminal device may send the first capability information to the network device after the random access procedure.

The first number and/or the second number may be an integer equal to or greater than 1. For example, the first number and/or the second number may be 1, 2, 3, 4, 6, 8 or the like.

For example, if the N carriers include the first carrier and the second carrier, the terminal device may determine that the first number may be 1 or 2. For example, the second number may be 1 or 2.

The situation that the terminal device supports switching of the first number of carriers or supports switching of the second number of transmission links may include that the terminal device supports simultaneous switching of the first number of carriers and/or supports simultaneous switching of the second number of transmission links, or, the terminal device supports switching of the first number of carriers in one slot and/or supports switching of the second number of transmission links in one slot, or the terminal device supports switching of the first number of carriers in at least two slots and/or supports switching of the second number of transmission links in at least two slots.

In some embodiments, the carrier switching method further includes the following operations. The terminal device sends second capability information.

The second capability information indicates that a processing time length of switching a third number of carriers by the terminal device, the third number being less than or equal to the first number; and/or a processing time length of switching a fourth number of transmission links by the terminal device, the fourth number being less than or equal to the second number.

For example, if the terminal device supports switching of two carriers, the second capability information may include a processing time length of switching one and/or two carriers by the terminal device. For another example, if the terminal device supports switching of two transmission links, the second capability information may include a processing time length of switching one or two transmission links by the terminal device.

In some embodiments, a total processing time length of switching S carriers by the terminal device may be less than, equal to or greater than a product of S multiplying the processing time length of switching one carrier. S is an integer equal to or greater than 2. Exemplarily, the total processing time length of switching S carriers may be less than the product of S multiplying the processing time length of switching one carrier. For example, switching of multiple carriers may be performed by the terminal device simultaneously (or, in one slot). In this case, the terminal device may switch S carriers in parallel, and the processing time length of switching S carriers may be the same as the processing time length of switching one carrier. Exemplarily, the total processing time length of S carriers may be equal to the product of S multiplying the processing time length of switching one carrier. In this case, switching of multiple carriers may be performed by the terminal device in serial, that is, the terminal device switches the carriers one by one. Exemplarily, the total processing time length of switching S carriers may be greater than the product of S multiplying the processing time length of switching one carrier. In this case, switching of multiple carriers may be performed by the terminal device in serial, and additional processing time is required between switching of the carriers, for example, after switching of one carrier, an interval of additional processing time is required before switching of another carrier.

In some embodiments, the second capability information may be determined based on the first capability information. For example, the processing time length included in the second capability information may be determined based on the first number and/or the second number included in the first capability information.

In some embodiments, the processing time length is equal to or greater than 0 microseconds (μs) and less than or equal to 420 μs.

For example, the processing time length may include one of 0 μs, 35 μs, 70 μs, 100 μs, 140 μs, 210 μs, 280 μs, 350 μs, or 420 μs.

In some embodiments, the first switching information is carried in MAC signaling, and the operation that the terminal device sends information on the M carriers includes the following operations.

The terminal device sends information on the M carriers in an effective slot corresponding to the MAC signaling and after the effective slot.

In some embodiments, the terminal device may send information on a carrier before switching at a time when the MAC signaling is received and before the effective slot. In some other embodiments, the terminal device may not send information at the time when the MAC signaling is received and before the effective slot.

In some embodiments, the effective slot is the first slot after an effective time length corresponding to the MAC signaling elapses, the effective time length is determined based on a sum of a first time length and the processing time length, the first time length is equal to or greater than 0.1 milliseconds (ms) and less than or equal to 5 ms, or the first time length is equal to or greater than a number of symbols corresponding to 0.1 ms at a subcarrier interval and less than or equal to a number of symbols corresponding to 5 ms at the subcarrier interval. For example, the first time length may be 0.1 ms, 1 ms, 2 ms, 3 ms, 4 ms or 5 ms; or the first time length may be the number of symbols corresponding to 0.1 ms, 1 ms, 2 ms, 3 ms, 4 ms or 5 ms at the subcarrier interval. One time length includes different numbers of symbols on different subcarriers. In the embodiment, the effective slot may be a sum of the time when the MAC signaling is received and the effective time length, or the effective slot may be a sum of the time when the MAC signaling is received and one slot after the slot on which the effective time length is obtained.

The time when the MAC signaling is received may refer to a slot where the MAC signaling is received and/or a symbol where the MAC signaling is received, or the time when the MAC signaling is received may be understood as a slot and/or symbol where the terminal device feeds back a HARQ corresponding to the MAC signaling.

In some embodiments, the effective time length may be the sum of the first time length and the processing time length (that is, the effective time length=the first time length+the processing time length). The processing time length may also be referred to as a switching time length. For example, the effective time length is a sum of 3 ms and the processing time length. Different processing time lengths correspond to different effective time lengths.

In some embodiments, the processing time length may be a time length occupied by at least one symbol.

In some embodiments, the effective slot is a slot after a target slot, the target slot is determined based on at least one of a slot corresponding to HARQ-ACK feedback for the MAC signaling, the number of slots in a subframe corresponding to a subcarrier interval, or the number of symbols corresponding to the processing time length.

The effective slot and the target slot may be adjacent slots, or the effective slot may be separated from the target slot by at least one slot.

In some embodiments, the target slot may be determined based on a sum of a slot corresponding to HARQ-ACK feedback for the MAC signaling, a product of multiplying a target value with the number of slots in the subframe corresponding to the subcarrier interval, and the number of symbols corresponding to the processing time length, or the target slot may be the sum of the slot corresponding to HARQ-ACK feedback for the MAC signaling, a product of multiplying a target value with the number of slots in the subframe corresponding to the subcarrier interval, and the number of symbols corresponding to the processing time length.

A value range of the target value may be from 1 to 5. For example, the target value may be 1, 2, 3, 4 or 5.

In a case that the subcarrier interval is 15 KHz, the number of slots in a subframe corresponding to the subcarrier interval 15 KHz is 1. In a case that the subcarrier interval is 30 KHz, a number of slots in a subframe corresponding to the subcarrier interval 30 KHz is 2. In a case that the subcarrier interval is 60 KHz, a number of slots in a subframe corresponding to the subcarrier interval 60 KHz is 4. In a case that the subcarrier interval is 120 KHz, a number of slots in a subframe corresponding to the subcarrier interval 120 KHz is 8. In a case that the subcarrier interval is 240 KHz, a number of slots in a subframe corresponding to the subcarrier interval 240 KHz is 16.

In some embodiments, the terminal device may send capability of supporting switching of transmission links (Tx switching or uplink switching) in a specific frequency band combination to the network device or the target device, and supports switching of at most two or three transmission links.

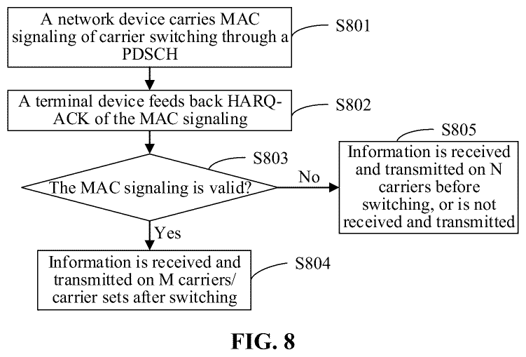

FIG. 8 is a schematic flowchart of switching carriers based on MAC signaling provided in an embodiment of the disclosure. As shown in FIG. 8, a method for switching carriers based on MAC signaling may include the following operations S801 to S805.

At S801, a network device carries MAC signaling for carrier switching through a Physical Downlink Shared Channel (PDSCH).

At S802, a terminal device feeds back a HARQ-ACK of the MAC signaling.

At S803, the terminal device determines whether the MAC signaling is effective.

If the MAC signaling is effective, S804 is executed, and if the MAC signaling is ineffective, S805 is executed.

At S804, the terminal device receives and sends information on M carriers/carrier sets.

At S805, the terminal device receives and sends information on N carriers before switching, or does not receive and send information on N carriers before switching.

In some embodiments, if the first switching information indicates switching one carrier. For example, before the terminal device performs switching, the transmission link of carrier 1 is 1Tx, and the transmission link of carrier 2 is 1Tx. In a case that carrier 1 or carrier 2 is switched to carrier 3, the transmission link of carrier 3 may be 1Tx or 2Tx. For another example, before the terminal device performs switching, the terminal device sends information through carrier 1 or carrier 2, the transmission link of carrier 1 or carrier 2 is 1Tx or 2Tx. In a case that carrier 1 or carrier 2 is switched to carrier 3, the transmission link of carrier 3 may be 1Tx or 2Tx. In the embodiment, the first switching information may include the third carrier index 3 and the number of transmission links corresponding to the third carrier, or the first switching information may include not only the first carrier index 1 or the second carrier index 2, but also the third carrier index 3 and the number of transmission links corresponding to the third carrier.

In some embodiments, if the first switching information indicates switching two carriers. For example, before the terminal device performs switching, the transmission link of carrier 1 is 1Tx, and the transmission link of carrier 2 is 1Tx. In a case that carrier 1 is switched to carrier 3 and carrier 2 is switched to carrier 4, the transmission link of each of carrier 3 and carrier 4 may be 1Tx. For another example, the terminal device sends information through carrier 1 or carrier 2 before switching, the transmission link of carrier 1 or carrier 2 is 2Tx, the first switching information may indicate that carrier 1 or carrier 2 is switched to carrier 3 and carrier 4, the transmission link of each of carrier 3 and carrier 4 may be 1Tx. In the embodiment, the first switching information may include the third carrier index 3, the fourth carrier index 4, the number of transmission links corresponding to the third carrier, and the number of transmission links corresponding to the fourth carrier, or the first switching information may include not only the first carrier index 1 and the second carrier index 2, but also the third carrier index 3, the fourth carrier index 4, the number of transmission links corresponding to the third carrier, and the number of transmission links corresponding to the fourth carrier.

By indicating situation of the transmission link after carrier switching, the terminal device can adjust the transmission link while switching the carrier, thereby simplifying implementation of the terminal device.

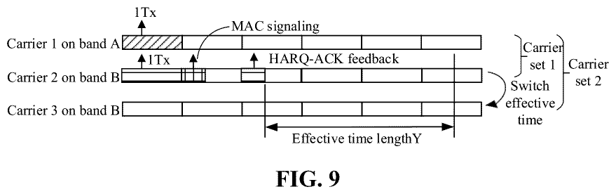

FIG. 9 is a schematic diagram of an effective time length of MAC signaling provided in an embodiment of the disclosure. As shown in FIG. 9, in some embodiments, the effective time length corresponding to the MAC signaling is Y, and Y is a total time length of the following two items. The first item includes 3 ms, or a number of slots corresponding to 3 ms at a subcarrier interval, or a number of symbols corresponding to 3 ms at the subcarrier interval. A value of the first item is the first time length described above. The second item includes a time length of switching transmission links (for example, the processing time length or the switching time length described above), the terminal device may start sending information on the switched carrier in a first slot after the effective time length. In some other embodiments, the effective slot corresponding to the MAC signaling is not earlier than k+3×t+1. k denotes a slot corresponding to HARQ-ACK feedback corresponding to the MAC signaling, and the HARQ-ACK feedback may be carried in the PUSCH or PUCCH; t denotes a number of slots in a subframe corresponding to a subcarrier interval of the PUSCH or PUCCH carrying the HARQ-ACK feedback; l denotes a number of symbols corresponding to the time length of switching transmission links, and/may be the number of symbols corresponding to the processing time length described above. The slot where the MAC signaling goes into effect may be a first slot after k+3×t+l. l may be a number of symbols corresponding to a time length of switching one, two, three or more than three transmission links. In some embodiments, the number of symbols corresponding to a time length of switching two transmission links may be twice a number of symbols corresponding to a time length of switching one transmission link.

While the MAC signaling goes into effect, since the terminal device cannot simultaneously process the MAC signaling and switch a transmission link, the effective time of the MAC signaling is determined by additionally considering the time of switching transmission links, to avoid transmission failure due to ambiguous states of the transmission links.

The network device may switch a carrier by using DCI. In some embodiments, the network device may add a carrier switching identification field into the DCI by reusing a carrier indication field (carrier indicator) in DCI. For example, the carrier switching identification field is for example 1 bit, 0 represents cross-carrier scheduling, 1 represents carrier switching. The terminal device may jointly detect the carrier indication field and the carrier switching identification field, and if the carrier switching identification field is 1, it means that the terminal device switches to a carrier indicated by the carrier indication field.

The effective time of switching a carrier by using the DCI may be the processing time or the effective slot described above. Since transmission interruption time caused by switching a carrier by using the DCI is short, switching carriers by using the DCI is beneficial to improve throughput.

In the embodiment of the disclosure, the first capability information and the second capability information may be reported in the same field or in different fields. The second capability information may also be predefined. For example, a user equipment (UE) supports simultaneous switching of two transmission links, and a default processing time is 210 μs in this case. A supported type of switching of carriers or transmission links is reported by the first capability information, and a supported processing time is reported by the second capability information, the network device is desired to configure according to contents reported by the capability information, thereby reducing complexity of implementation of the terminal device.

The first capability information and/or the second capability information in the embodiment of the disclosure may be selectively reported by the terminal device. If the terminal device does not report the first capability information and/or the second capability information, the network device may determine that the terminal device supports switching of one, two, three or more carriers by default, and/or the network device may determine that the terminal device supports switching of one, two, three or more links by default. If the terminal device does not report the first capability information and/or the second capability information, a number of bits of an Information Element (IE) sent by the terminal device may be reduced.

In the embodiment of the disclosure, if the terminal device receives the first switching information, but the terminal device does not receive the second switching information, the terminal device may switch from the first carrier to the third carrier and/or from the second carrier to the fourth carrier according to the first switching information. The terminal device may perform switching based on the following manners.

The number of transmission links corresponding to the third carrier is the same as the number of transmission links of the first carrier, and the number of transmission links corresponding to the fourth carrier is the same as the number of transmission links of the second carrier.

The number of transmission links corresponding to the third carrier is consistent with the number of transmission links supported by the terminal device corresponding to the operating frequency band combination, and the number of transmission links corresponding to the fourth carrier is consistent with the number of transmission links supported by the terminal device corresponding to the operating frequency band combination.

If two carriers are switched, the number of transmission links of the third carrier after switching and the number of transmission links of the fourth carrier after switching each is 1Tx. If one carrier is switched, the number of transmission links of the third carrier after switching or the number of transmission links of the fourth carrier after switching are 2Tx, so that the terminal device may transmit information with a large power in a good channel state.

A problem of an ambiguous state of the transmission link may be avoided by defining operations of the terminal device when the terminal device does not receive the second switching information.

The carrier switching method in the embodiment of the disclosure is described below by taking the network device as an example.

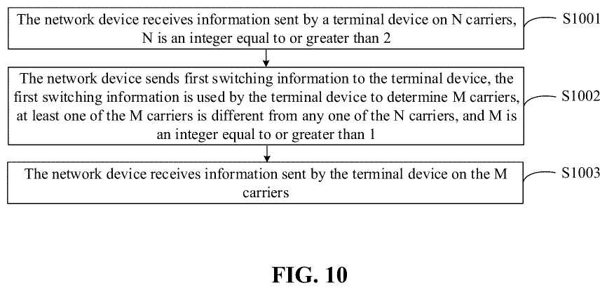

FIG. 10 is a schematic flowchart of another carrier switching method provided in an embodiment of the disclosure. As shown in FIG. 10, the method is applied to a network device, and the method includes the following operations S1001 to S1003.

At S1001, the network device receives information sent by a terminal device on N carriers, N being an integer equal to or greater than 2.

At S1002, the network device sends first switching information to the terminal device, the first switching information is used by the terminal device to determine M carriers, and at least one of the M carriers is different from any one of the N carriers, M being an integer equal to or greater than 1.

At S1003, the network device receives information sent by the terminal device on the M carriers.

In some embodiments, different carriers of the N carriers are located at different operating frequency bands. Alternatively, at least two of the N carriers are located at the same operating frequency band.

In some embodiments, operating frequency bands where different carriers of the N carriers are located are different from each other; or, operating frequency bands where at least two of the N carriers are located are the same with each other.

In some embodiments, an operating frequency band where any carrier of at least one of the M carriers is located is different from an operating frequency band where each of the N carriers is located.

Alternatively, operating frequency bands where one or more carriers of the at least one of the M carriers are located are the same as operating frequency bands where one or more carriers of the N carriers are located respectively.

In some embodiments, the first switching information is carried in RRC signaling.

Alternatively, the first switching information is carried in MAC signaling.

Alternatively, the first switching information is carried in DCI.

In some embodiments, the operation of the network device receives information sent by the terminal device on the N carriers includes the following operations. The network device receives information sent by the terminal device on a transmission link corresponding to each of the N carriers.

The operation of the network device receives information sent by the terminal device on the M carriers includes the following operations. The network device receives information sent by the terminal device on a transmission link corresponding to each of the M carriers.

In some embodiments, at least one of the N carriers is switched to R carriers, the R carriers are not contained in the N carriers, the R carriers are the M carriers, or the R carriers and a carrier of the N carriers which is not switched constitute the M carriers.

The carrier switching method further includes the following operations. The network device sends second switching information to the terminal device, the second switching information includes or is configured to indicate at least one of the number of transmission links corresponding to each of the R carriers, the number of transmission links corresponding to each of the M carriers, or the number of transmission links corresponding to each of the at least one of the N carriers.

In some embodiments, the N carriers belong to a first carrier set, and the M carriers belong to a second carrier set.

The first switching information indicates switching the first carrier set to the second carrier set.

In some embodiments, a carrier index of any carrier in the first carrier set and/or an operating frequency band index to which any carrier in the first carrier set belongs is greater than a carrier index of any carrier in the second carrier set and/or an operating frequency band index to which any carrier in the second carrier set belongs.

Alternatively, a carrier index of any carrier in the first carrier set and/or an operating frequency band index to which any carrier in the first carrier set belongs is less than a carrier index of any carrier in the second carrier set and/or an operating frequency band index to which any carrier in the second carrier set belongs.

In some embodiments, carriers in the first carrier set are at least partially the same as carriers in the second carrier set.

Alternatively, any one of the carriers in the first carrier set is different from each of the carriers in the second carrier set.

In some embodiments, N is 2, the N carriers include a first carrier and a second carrier, and the first switching information is configured to indicate one of: switching the first carrier to a third carrier; or switching the second carrier to a fourth carrier; or switching the first carrier to the third carrier and switching the second carrier to the fourth carrier.

In some embodiments, the carrier switching method further includes at least one of: determining the number of transmission links corresponding to the third carrier; or determining the number of transmission links corresponding to the fourth carrier.

In some embodiments, the number of transmission links corresponding to the third carrier is the same as the number of transmission links corresponding to the first carrier, and/or, the number of transmission links corresponding to the fourth carrier is the same as the number of transmission links corresponding to the second carrier.

In some embodiments, the third carrier is associated with a first frequency band combination, the number of transmission links corresponding to the third carrier is the same as the number of transmission links supported by the terminal device corresponding to the first frequency band combination.

The fourth carrier is associated with a second frequency band combination, the number of transmission links corresponding to the fourth carrier is the same as the number of transmission links supported by the terminal device corresponding to the second frequency band combination.

In some embodiments, in a case that the first carrier is switched to the third carrier, the number of transmission links corresponding to the third carrier is 1 or 2.

In a case that the second carrier is switched to the fourth carrier, the number of transmission links corresponding to the fourth carrier is 1 or 2.

In a case that the first carrier is switched to the third carrier and the second carrier is switched to the fourth carrier, each of the number of transmission links corresponding to the third carrier and the number of transmission links corresponding to the fourth carrier is 1.

In some embodiments, the number of transmission links corresponding to the third carrier and/or the number of transmission links corresponding to the fourth carrier is determined by the network device based on configuration information of the network device.

Alternatively, the number of transmission links corresponding to the third carrier and/or the number of transmission links corresponding to the fourth carrier is determined based on the second switching information.

In some embodiments, the carrier switching method further includes the following operations. The network device receives first capability information sent by the terminal device, the first capability information indicates that the terminal device supports switching of a first number of carriers, and/or that the terminal device supports switching of a second number of transmission links.

In some embodiments, the carrier switching method further includes the following operations. The network device receives second capability information sent by the terminal device, the second capability information indicates that a processing time length of switching a third number of carriers by the terminal device, the third number being less than or equal to the first number; and/or that a processing time length of switching a fourth number of transmission links by the terminal device, the fourth number being less than or equal to the second number.

In some embodiments, the processing time length is equal to or greater than 0 μs and less than or equal to 420 μs.

In some embodiments, the processing time length includes one of 0 μs, 35 μs, 70 μs, 100 μs, 140 μs, 210 μs, 280 μs, 350 μs, or 420 μs.

In some embodiments, the first switching information is carried in MAC signaling, and the operation of the network device receives information sent by the terminal device on the M carriers includes the following operations.

The network device receives information sent by the terminal device on the M carriers in an effective slot corresponding to the MAC signaling and after the effective slot.

In some embodiments, the effective slot is the first slot after an effective time length corresponding to the MAC signaling elapses.

The effective time length is determined based on a sum of a first time length and the processing time length, the first time length is equal to or greater than 0.1 ms and less than or equal to 5 ms, or, the first time length is equal to or greater than the number of symbols corresponding to 0.1 ms at a subcarrier interval and less than or equal to the number of symbols corresponding to 5 ms at the subcarrier interval.

In some embodiments, the effective slot is a slot after a target slot, the target slot is determined based on at least one of a slot corresponding to HARQ-ACK feedback for the MAC signaling, the number of slots in a subframe corresponding to a subcarrier interval, or the number of symbols corresponding to the processing time length.

Some implementations of the present disclosure have been described in detail as above with reference to the drawings. However, the disclosure is not limited to specific details in the above implementations. Multiple simple variations may be made to the technical solutions of the disclosure within the scope of the technical concept of the disclosure, and all these simple variations fall within the scope of protection of the disclosure. For example, the specific technical features described in the above specific implementations may be combined in any suitable way without conflict, and various possible combination modes will not be described in the disclosure to avoid unnecessary repetition. For another example, various different implementations of the disclosure may also be arbitrarily combined, as long as such combination does not violate the idea of the disclosure, and the combinations should also be considered as contents disclosed in the disclosure. For another example, the embodiment described in the disclosure and/or technical features in each embodiment may be arbitrarily combined with the related art without conflict, and technical solutions obtained after such combination should also fall within the scope of protection of the disclosure.

It should also be understood that in various method embodiments of the disclosure, serial numbers of the above processes do not mean an execution sequence of the processes. The execution sequence of each of the processes should be determined by its functions and internal logic, and should not constitute any limitation on implementation of the embodiments of the disclosure. Furthermore, in the embodiments of the disclosure, terms “downlink”, “uplink” and “sidelink” indicate transmission directions of signals or data, “downlink” indicates that a transmission direction of a signal or data is a first direction of sending a signal or data from a station to UE of a cell, “uplink” indicates that a transmission direction of a signal or data is a second direction of sending a signal or data from UE of a cell to a station, and “sidelink” indicates that a transmission direction of a signal or data is a third direction of sending a signal or data from UE1 to UE2. For example, “downlink signal” indicates that a transmission direction of the signal is the first direction. Furthermore, in the embodiments of the disclosure, term “and/or” is only an association relationship describing associated objects, and indicates that there may be three relationships. Specifically, A and/or B may indicate three situations, that is, A exists alone, A and B exist simultaneously, and B exists alone. Furthermore, a character “/” here usually indicates that anterior and posterior associated objects are in a “or” relationship.

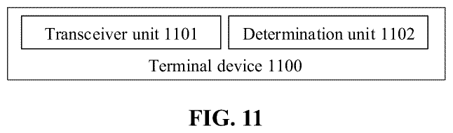

FIG. 11 is a schematic diagram of a composition structure of a terminal device in an embodiment of the disclosure. As shown in FIG. 11, the terminal device 1100 includes a transceiver unit 1101 and a determination unit 1102.

The transceiver unit 1101 is configured to send information on N carriers, N is an integer equal to or greater than 2.

The determination unit 1102 is configured to determine M carriers based on obtained first switching information, at least one of the M carriers is different from any one of the N carriers, and M is an integer equal to or greater than 1.

The transceiver unit 1101 is further configured to send information on the M carriers.

In some embodiments, operating frequency bands where different carriers of the N carriers are located are different with each other; or operating frequency bands where at least two of the N carriers are located are the same with each other.

In some embodiments, an operating frequency band where any carrier from at least one of the M carriers is located is different from an operating frequency band where each of the N carriers is located.

Alternatively, operating frequency bands where one or more carriers from the at least one of the M carriers are located are the same as operating frequency bands where one or more carriers of the N carriers are located.

In some embodiments, the first switching information is sent by a network device.

The first switching information is carried in RRC signaling.

Alternatively, the first switching information is carried in MAC signaling.

Alternatively, the first switching information is carried in DCI.

In some embodiments, the transceiver unit 1101 is further configured to send information on a transmission link corresponding to each of the N carriers, and the transceiver unit 1101 is further configured to send information on a transmission link corresponding to each of the M carriers.

In some embodiments, the M carriers are R carriers switched from at least one of the N carriers. R carriers are not included in the N carriers. The R carriers are the M carriers, or the R carriers and a carrier of the N carriers which is not switched constitute the M carriers. The determination unit 1102 is further configured to obtain second switching information, the second switching information includes or is configured to indicate at least one of: the number of transmission links corresponding to each of the R carriers; the number of transmission links corresponding to each of the M carriers; or the number of transmission links corresponding to each of the at least one of the N carriers.

In some embodiments, the N carriers belong to a first carrier set, the M carriers belong to a second carrier set. The first switching information indicates switching the first carrier set to the second carrier set.

In some embodiments, a carrier index of any carrier in the first carrier set and/or an index of an operating frequency band to which any carrier in the first carrier set belongs is greater than a carrier index of any carrier in the second carrier set and/or an index of an operating frequency band to which any carrier in the second carrier set belongs. Alternatively, the carrier index of any carrier in the first carrier set and/or the index of the operating frequency band to which any carrier in the first carrier set belongs is less than the carrier index of any carrier in the second carrier set and/or the index of the operating frequency band to which any carrier in the second carrier set belongs.

In some embodiments, carriers in the first carrier set are at least partially the same as carriers in the second carrier set, or, any one of the carriers in the first carrier set is different from each of the carriers in the second carrier set.

In some embodiments, N is 2, the N carriers include a first carrier and a second carrier. The first switching information indicates one of switching the first carrier to a third carrier; switching the second carrier to a fourth carrier; or switching the first carrier to the third carrier, and switching the second carrier to the fourth carrier.

In some embodiments, the determination unit 1102 is further configured to perform at least one of determining the number of transmission links corresponding to the third carrier; or determining the number of transmission links corresponding to the fourth carrier.

In some embodiments, the number of transmission links corresponding to the third carrier is the same as the number of transmission links corresponding to the first carrier; and/or, the number of transmission links corresponding to the fourth carrier is the same as a number of transmission links corresponding to the second carrier.

In some embodiments, the third carrier is associated with a first frequency band combination, the number of transmission links corresponding to the third carrier is the same as the number of transmission links supported by the terminal device corresponding to the first frequency band combination. The fourth carrier is associated with a second frequency band combination, the number of transmission links corresponding to the fourth carrier is the same as the number of transmission links supported by the terminal device corresponding to the second frequency band combination.

In some embodiments, in a case that the first carrier is switched to the third carrier, the number of transmission links corresponding to the third carrier is 1 or 2. In a case that the second carrier is switched to the fourth carrier, the number of transmission links corresponding to the fourth carrier is 1 or 2. In a case that the first carrier is switched to the third carrier and the second carrier is switched to the fourth carrier, each of the number of transmission links corresponding to the third carrier and the number of transmission links corresponding to the fourth carrier is 1.

In some embodiments, the number of transmission links corresponding to the third carrier and/or the number of transmission links corresponding to the fourth carrier is determined by the terminal device based on configuration information of the terminal device. Alternatively, the number of transmission links corresponding to the third carrier and/or the number of transmission links corresponding to the fourth carrier is determined by the terminal device based on second switching information received from a network device.

In some embodiments, the transceiver unit 1101 is further configured to send first capability information, and the first capability information indicates that the terminal device supports switching of a first number of carriers; and/or that the terminal device supports switching of a second number of transmission links.

In some embodiments, the transceiver unit 1101 is further configured to send second capability information, and the second capability information indicates that a processing time length of switching a third number of carriers by the terminal device, the third number being less than or equal to the first number; and/or a processing time length of switching a fourth number of transmission links by the terminal device, the fourth number being less than or equal to the second number.

In some embodiments, the processing time length is equal to or greater than 0 μs and less than or equal to 420 μs.

In some embodiments, the processing time length includes one of 0 μs, 35 μs, 70 μs, 100 μs, 140 μs, 210 μs, 280 μs, 350 μs, or 420 μs.

In some embodiments, the first switching information is carried in MAC signaling, and the transceiver unit 1101 is further configured to send information on the M carriers in an effective slot corresponding to the MAC signaling and after the effective slot.

In some embodiments, the effective slot is the first slot after an effective time length corresponding to the MAC signaling elapses, the effective time length is determined based on a sum of a first time length and the processing time length, the first time length is equal to or greater than 0.1 ms and less than or equal to 5 ms, or the first time length is equal to or greater than the number of symbols corresponding to 0.1 ms at a subcarrier interval and less than or equal to the number of symbols corresponding to 5 ms at the subcarrier interval.

In some embodiments, the effective slot is a slot after a target slot, the target slot is determined based on at least one of a slot corresponding to HARQ-ACK feedback for the MAC signaling, the number of slots in a subframe corresponding to a subcarrier interval, or the number of symbols corresponding to the processing time length.

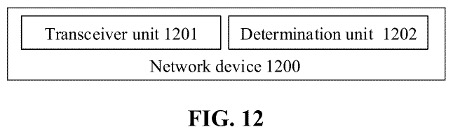

FIG. 12 is a schematic diagram of a composition structure of a network device provided in an embodiment of the disclosure. As shown in FIG. 12, the network device 1200 includes a transceiver unit 1201.

The transceiver unit 1201 is configured to receive information sent by a terminal device on N carriers, N being an integer equal to or greater than 2.

The transceiver unit 1201 is further configured to send first switching information to the terminal device. The first switching information is used by the terminal device to determine M carriers, at least one of the M carriers is different from any one of the N carriers, and M is an integer equal to or greater than 1.

The transceiver unit 1201 is further configured to receive information sent by the terminal device on the M carriers.

In some embodiments, the network device 1300 further includes a determination unit 1202 configured to determine the first switching information.

In some embodiments, different carriers of the N carriers are located at different operating frequency bands. Alternatively, at least two of the N carriers are located at the same operating frequency band.

In some embodiments, an operating frequency band where any carrier from at least one of the M carriers is located is different from an operating frequency band where each of the N carriers is located; or, operating frequency bands where one or more carriers from the at least one of the M carriers are located are the same as operating frequency bands where one or more carriers of the N carriers are located.

In some embodiments, the first switching information is carried in RRC signaling, or the first switching information is carried in MAC signaling, or the first switching information is carried in DCI.

In some embodiments, the transceiver unit 1201 is further configured to receive information sent by the terminal device on a transmission link corresponding to each of the N carriers, and the transceiver unit 1201 is further configured to receive information sent by the terminal device on a transmission link corresponding to each of the M carriers.

In some embodiments, at least one of the N carriers is switched to R carriers, the R carriers are not contained in the N carriers, the R carriers are the M carriers, or the R carriers and a carrier of the N carriers which is not switched constitute the M carriers. The transceiver unit 1201 is further configured to send second switching information to the terminal device, the second switching information includes or is configured to indicate at least one of: the number of transmission links corresponding to each of the R carriers; the number of transmission links corresponding to each of the M carriers; or the number of transmission links corresponding to each of the at least one of the N carriers.

In some embodiments, the N carriers belong to a first carrier set, the M carriers belong to a second carrier set. The first switching information indicates switching the first carrier set to the second carrier set.

In some embodiments, a carrier index of any carrier in the first carrier set and/or an index of an operating frequency band to which any carrier in the first carrier set belongs is greater than a carrier index of any carrier in the second carrier set and/or an index of an operating frequency band to which any carrier in the second carrier set belongs. Alternatively, the carrier index of any carrier in the first carrier set and/or the index of the operating frequency band to which any carrier in the first carrier set belongs is less than the carrier index of any carrier in the second carrier set and/or the index of the operating frequency band to which any carrier in the second carrier set belongs.

In some embodiments, carriers in the first carrier set are at least partially the same as carriers in the second carrier set, or, any one of the carriers in the first carrier set is different from each of the carriers in the second carrier set.

In some embodiments, N is 2, the N carriers include a first carrier and a second carrier. The first switching information indicates one of switching the first carrier to a third carrier; switching the second carrier to a fourth carrier; or switching the first carrier to the third carrier, and switching the second carrier to the fourth carrier.

In some embodiments, the determination unit 1202 is further configured to perform at least one of determining the number of transmission links corresponding to the third carrier; or determining the number of transmission links corresponding to the fourth carrier.

In some embodiments, the number of transmission links corresponding to the third carrier is the same as the number of transmission links corresponding to the first carrier; and/or, the number of transmission links corresponding to the fourth carrier is the same as a number of transmission links corresponding to the second carrier.

In some embodiments, the third carrier is associated with a first frequency band combination, the number of transmission links corresponding to the third carrier is the same as the number of transmission links supported by the terminal device corresponding to the first frequency band combination. The fourth carrier is associated with a second frequency band combination, the number of transmission links corresponding to the fourth carrier is the same as the number of transmission links supported by the terminal device corresponding to the second frequency band combination.

In some embodiments, in a case that the first carrier is switched to the third carrier, the number of transmission links corresponding to the third carrier is 1 or 2.

In a case that the second carrier is switched to the fourth carrier, the number of transmission links corresponding to the fourth carrier is 1 or 2.

In a case that the first carrier is switched to the third carrier and the second carrier is switched to the fourth carrier, each of the number of transmission links corresponding to the third carrier and the number of transmission links corresponding to the fourth carrier is 1.

In some embodiments, the number of transmission links corresponding to the third carrier and/or the number of transmission links corresponding to the fourth carrier is determined by the network device based on configuration information of the network device. Alternatively, the number of transmission links corresponding to the third carrier and/or the number of transmission links corresponding to the fourth carrier is determined based on second switching information.

In some embodiments, the transceiver unit 1201 is further configured to receive first capability information sent by the terminal device. The first capability information indicates that the terminal device supports switching of a first number of carriers; and/or that the terminal device supports switching of a second number of transmission links.

In some embodiments, the transceiver unit 1201 is further configured to receive second capability information sent by the terminal device, the second capability information indicates that a processing time length of switching a third number of carriers by the terminal device, the third number being less than or equal to the first number; and/or a processing time length of switching a fourth number of transmission links by the terminal device, the fourth number being less than or equal to the second number

In some embodiments, the processing time length is equal to or greater than 0 μs and less than or equal to 420 μs.

In some embodiments, the processing time length includes one of 0 μs, 35 μs, 70 μs, 100 μs, 140 μs, 210 μs, 280 μs, 350 μs, or 420 μs.

In some embodiments, the first switching information is carried in MAC signaling, and the transceiver unit 1201 is further configured to receive information sent by the terminal device on the M carriers in an effective slot corresponding to the MAC signaling and after the effective slot.

In some embodiments, the effective slot is the first slot after an effective time length corresponding to the MAC signaling elapses.

The effective time length is determined based on a sum of a first time length and the processing time length, the first time length is equal to or greater than 0.1 ms and less than or equal to 5 ms, or the first time length is equal to or greater than the number of symbols corresponding to 0.1 ms at a subcarrier interval and less than or equal to the number of symbols corresponding to 5 ms at the subcarrier interval.

In some embodiments, the effective slot is a slot after a target slot, the target slot is determined based on at least one of a slot corresponding to HARQ-ACK feedback for the MAC signaling, the number of slots in a subframe corresponding to a subcarrier interval, or the number of symbols corresponding to the processing time length.

It should be understood by those skilled in the art that relevant descriptions of the terminal device or network device described above according to the embodiments of the disclosure may be understood with reference to relevant descriptions of the carrier switching method according to the embodiments of the disclosure.

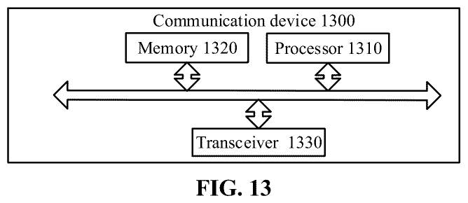

FIG. 13 is a schematic structural diagram of a communication device provided in an embodiment of the disclosure. The communication device may be a terminal device or a network device. The communication device 1300 shown in FIG. 13 includes a processor 1310 and a memory 1320. The memory 1320 stores a computer program executable on the processor 1310. The processor 1310, when executing the program, implements the carrier switching method in any one of the above embodiments.

The memory 1320 may be a separate device independent of the processor 1310, or may be integrated into the processor 1310.

In some embodiments, as shown in FIG. 13, the communication device 1300 may further include a transceiver 1330. The processor 1310 may control the transceiver 1330 to communicate with other devices. Specifically, the processor 1310 may control the transceiver 1330 to send information or data to other devices, or receive information or data sent by other devices. The transceiver 1330 may include a transmitter and a receiver. The transceiver 1330 may further include an antenna, and there may be one or more antennas.

In some embodiments, the communication device 1300 may be the network device according to the embodiments of the disclosure, and the communication device 1300 may implement processes in each method according to the embodiments of the disclosure which are implemented by the network device, which are not elaborated here, for the sake of brevity.

In some embodiments, the communication device 1300 may be the terminal device according to the embodiments of the disclosure, and the communication device 1300 may implement processes in each method according to the embodiments of the disclosure which are implemented by the terminal device, which are not elaborated here, for the sake of brevity.

The embodiments of the disclosure further provides a computer storage medium, the computer storage medium stores one or more programs, the one or more programs are executable by one or more processors, to implement the methods in the embodiments of the disclosure.

In some embodiments, the computer storage medium may be applied to the network device in the embodiments of the disclosure, and the computer program enables a computer to execute processes in each method according to the embodiments of the disclosure which are implemented by the network device. The processes are not elaborated here, for the sake of brevity.

In some embodiments, the computer storage medium may be applied to the terminal device in the embodiments of the disclosure, and the computer program enables a computer to execute processes in each method according to the embodiments of the disclosure which are implemented by the terminal device. The processes are not elaborated here, for the sake of brevity.

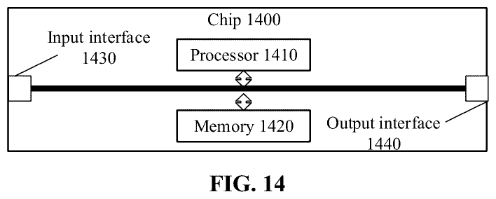

FIG. 14 is a schematic structural diagram of a chip according to an embodiment of the disclosure. The chip 1400 shown in FIG. 14 includes a processor 1410. The processor 1410 may call and run a computer program from a memory, to implement the method in any one of the embodiments of the disclosure.

In some embodiments, as shown in FIG. 14, the chip 1400 may further include a memory 1420. The processor 1410 may call and run the computer program from the memory 1420, to implement the methods in the embodiments of the disclosure.

The memory 1420 may be a separate device independent of the processor 1410, or may be integrated into the processor 1410.

In some embodiments, the chip 1400 may further include an input interface 1430. The processor 1410 may control the input interface 1430 to communicate with other devices or chips. Specifically, the processor 1410 may control the input interface 1430 to acquire information or data sent by other devices or chips.

In some embodiments, the chip 1400 may further include an output interface 1440. The processor 1410 may control the output interface 1440 to communicate with other devices or chips. Specifically, the processor 1410 may control the output interface 1440 to output information or data to other devices or chips.

In some embodiments, the chip may be applied to the network device in the embodiments of the disclosure, and the chip may implement processes in each method according to the embodiments of the disclosure which are implemented by the network device. The processes are not elaborated here, for the sake of brevity.

In some embodiments, the chip may be applied to the terminal device in the embodiments of the disclosure, and the chip may implement processes in each method according to the embodiments of the disclosure which are implemented by the terminal device. The processes are not elaborated here, for the sake of brevity.

It should be understood that the chip mentioned in the embodiments of the disclosure may also be referred to as a system-level chip, a system chip, a chip system, or a system-on-chip (SoC) chip, etc.

The embodiments of the disclosure further provides a computer program product, the computer program product includes a computer storage medium storing a computer program, the computer program includes instructions executable by at least one processor, the instructions implement the methods in the embodiments of the disclosure when the instructions are executed by the at least one processor.

In some embodiments, the computer program product may be applied to the network device in the embodiments of the disclosure, and the computer program instructions enable a computer to execute processes in each method according to the embodiments of the disclosure which are implemented by the network device. The processes are not elaborated here, for the sake of brevity.

In some embodiments, the computer program product may be applied to the terminal device in the embodiments of the disclosure, and the computer program instructions enable a computer to execute processes in each method according to the embodiments of the disclosure which are implemented by the terminal device. The processes are not elaborated here, for the sake of brevity.

The embodiment of the disclosure further provides a computer program, and the computer program enables a computer to execute the methods in the embodiments of the disclosure.

In some embodiments, the computer program may be applied to the network device in the embodiments of the disclosure, and when the computer program is run on a computer, the computer program enables the computer to execute processes in each method according to the embodiments of the disclosure which are implemented by the network device. The processes are not elaborated here, for the sake of brevity. In some embodiments, the computer program may be applied to the terminal device in the embodiments of the disclosure, and when the computer program is run on a computer, the computer program enables the computer to execute processes in each method according to the embodiments of the disclosure which are implemented by the terminal device. The processes are not elaborated here, for the sake of brevity.

The processor in the embodiments of the disclosure may be an integrated circuit chip having signal processing capability. During implementation, each operation of the above method embodiments may be completed by an integrated logic circuit in hardware in the processor or instructions in software. The above processor may include integration of any one or more of: a general-purpose processor, an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a Graphics Processing Unit (GPU), an embedded neural-network processing unit (NPU), a controller, a microcontroller, a microprocessor, a programmable logic unit, a discrete gate or a transistor logic device, a discrete hardware component, to implement or perform each method, operation and logical block diagram disclosed in the embodiments of the disclosure. The general-purpose processor may be a microprocessor, or any conventional processor, etc. Operations of the methods disclosed in combination with the embodiments of the disclosure may be directly embodied to be performed and completed by a hardware decoding processor, or by a combination of hardware in the decoding processor and a software module. The software module may be located in a mature storage medium in the field such as a random memory, a flash memory, a Read-Only Memory (ROM), a Programmable ROM (PROM) or an electrically erasable programmable memory, a register, or the like. The storage medium is located in a memory, and the processor reads information in the memory and completes operations of the above methods in combination with hardware thereof.

The memory or computer storage medium in the embodiments of the disclosure may be a volatile memory or a non-volatile memory, or may include both volatile and non-volatile memories. The non-volatile memory may be a ROM, a PROM, an Erasable PROM (EPROM), an Electrically EPROM (EEPROM), or a flash memory. The volatile memory may be a Random Access Memory (RAM) used as an external cache. By way of exemplary rather than restrictive descriptions, many forms of RAMs are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a SynchLink DRAM (SLDRAM), a Direct Rambus RAM (DR RAM). It should be noted that memories of the systems and methods described here are intended to include, but are not limited to these and any other suitable types of memories.

It should be understood that the above memories or computer storage media are exemplary rather than restrictive. For example, the memories in the embodiments of the disclosure may also be a static RAM (SRAM), a DRAM, an SDRAM, a DDR SDRAM, an ESDRAM, an SLDRAM, DR RAM, or the like. That is, the memories in the embodiments of the disclosure include, but are not limited to these and any other suitable types of memories.

It may be appreciated by those of ordinary skill in the art that units and algorithm steps of each example described in combination with the embodiments disclosed here may be implemented by electronic hardware, or a combination of computer software and electronic hardware. Whether these functions are performed in hardware or software depends on specific applications and design constraints of the technical solutions. Professional technicians may use different methods in specific applications to implement the described functions, however, such implementation should not be considered as going beyond the scope of the disclosure.

It may be clearly understood by those skilled in the art that for the sake of convenience and brevity of descriptions, regarding specific operation processes of the above systems, apparatuses and units, reference may be made to corresponding processes in the foregoing method embodiments, which are not elaborated here.

In several embodiments provided in the disclosure, it should be understood that the disclosed systems, apparatuses and methods may be implemented in other ways. For example, the above apparatus embodiments are only illustrative. For example, division of the units is only a logical function division. In an actual implementation, there may be other division manners. For example, multiple units or components may be combined or may be integrated into another system, or some features may be ignored or may not be performed. In another point, mutual coupling or direct coupling or communication connection as shown or discussed may be indirect coupling or communication connection through some interfaces, devices or units, and may be in electrical, mechanical or other forms.

The units described as separate components may be or may not be physically separated, and the components displayed as units may be or may not be physical units, that is, they may be located at one place, or may be distributed on multiple network units. Part or all of the units may be selected according to actual requirements, to achieve the purpose of the solutions of the embodiments.

Furthermore, functional units in each embodiment of the disclosure may be integrated into one processing unit, or the units may separately exist physically, or two or more units may be integrated into one unit.

When the functions are implemented in form of a software function unit and sold or used as an independent product, the functions may be stored in a computer storage medium. Based on such understanding, the technical solutions of the disclosure substantially or parts making contributions to the related art or part of the technical solutions may be embodied in form of a software product, and the computer software product is stored in a storage medium, includes several instructions to enable a computer device (which may be a personal computer, a server, or a network device, etc.) to execute all or part of operations of the method described in each embodiment of the disclosure. The foregoing storage medium includes various media capable of storing program codes, such as a U disk, a mobile hard disk, a ROM, a RAM, a magnetic disk or an optical disk, etc. The above descriptions are only specific implementations of the disclosure, however, the scope of protection of the disclosure is not limited thereto. Variations or replacements easily conceived by any technician familiar with this technical field within the technical scope disclosed in the disclosure, should fall within the scope of protection of the disclosure. Therefore, the scope of protection of the disclosure shall be subjected to the scope of protection of the claims.

1. A carrier switching method, comprising:
sending, by a terminal device, information on N carriers, N being an integer equal to or greater than 2;
determining, by the terminal device, M carriers based on obtained first switching information, wherein at least one of the M carriers is different from any one of the N carriers, and M is an integer equal to or greater than 1; and
sending, by the terminal device, information on the M carriers.

2. The method of claim 1, wherein different carriers of the N carriers are located at different operating frequency band, or at least two of the N carriers are located at a same operating frequency band.

3. The method of claim 1, wherein any carrier of at least one of the M carriers is located at a different operating frequency band from an operating frequency band where each of the N carriers is located; or
one or more carriers of the at least one of the M carriers are located at a same operating frequency band as operating frequency bands where one or more carriers of the N carriers are located.

4. The method of claim 1, wherein the first switching information is sent by a network device,
the first switching information is carried in Radio Resource Control (RRC) signaling, or
the first switching information is carried in Medium Access Control (MAC) signaling, or
the first switching information is carried in Downlink Control Information (DCI).

5. The method of claim 1, wherein the N is 2, and the N carriers comprise a first carrier and a second carrier, the first switching information indicates one of:
switching the first carrier to a third carrier;
switching the second carrier to a fourth carrier; or
switching the first carrier to the third carrier, and switching the second carrier to the fourth carrier.

6. The method of claim 5, further comprising at least one of:
determining a number of transmission links corresponding to the third carrier; or
determining a number of transmission links corresponding to the fourth carrier.

7. The method of claim 5, wherein a number of transmission links corresponding to the third carrier is the same as a number of transmission links corresponding to the first carrier; and/or
a number of transmission links corresponding to the fourth carrier is the same as a number of transmission links corresponding to the second carrier.

8. The method of claim 5, wherein in case that the first carrier is switched to the third carrier, a number of transmission links corresponding to the third carrier is 1 or 2,
in case that the second carrier is switched to the fourth carrier, a number of transmission links corresponding to the fourth carrier is 1 or 2,
in case that the first carrier is switched to the third carrier and the second carrier is switched to the fourth carrier, each of the number of transmission links corresponding to the third carrier and the number of transmission links corresponding to the fourth carrier is 1.

9. The method of claim 1, further comprising: sending, by the terminal device, first capability information,
wherein the first capability information indicates that:
the terminal device supports switching of a first number of carriers; and/or
the terminal device supports switching of a second number of transmission links.

10. The method of claim 9, further comprising: sending, by the terminal device, second capability information,
wherein the second capability information indicates:
a processing time length of switching a third number of carriers by the terminal device, the third number being less than or equal to the first number; and/or
a processing time length of switching a fourth number of transmission links by the terminal device, the fourth number being less than or equal to the second number.

11. The method of claim 10, wherein the processing time length is equal to or greater than 0 μs and less than or equal to 420 μs.

12. The method of claim 11, wherein the processing time length comprises one of 0 μs, 35 μs, 70 μs, 100 μs, 140 μs, 210 μs, 280 μs, 350 μs, or 420 μs.

13. A terminal device, comprising:
a transceiver;
a memory; and
a processor,
wherein the memory stores a computer program executable on the processor, and the processor is configured to execute the computer program to:
control the transceiver to send information on N carriers, N being an integer equal to or greater than 2;
determine M carriers based on obtained first switching information, wherein at least one of the M carriers is different from any one of the N carriers, and M is an integer equal to or greater than 1; and
control the transceiver to send information on the M carriers.

14. The terminal device of claim 13, wherein different carriers of the N carriers are located at different operating frequency band, or at least two of the N carriers are located at a same operating frequency band.

15. The terminal device of claim 13, wherein any carrier of at least one of the M carriers is located at a different operating frequency band from an operating frequency band where each of the N carriers is located; or
one or more carriers of the at least one of the M carriers are located at a same operating frequency band as operating frequency bands where one or more carriers of the N carriers are located.

16. The terminal device of claim 13, wherein the first switching information is sent by a network device,
the first switching information is carried in Radio Resource Control (RRC) signaling, or
the first switching information is carried in Medium Access Control (MAC) signaling, or
the first switching information is carried in Downlink Control Information (DCI).

17. A network device, comprising:
a transceiver;
a memory; and
a processor,
wherein the memory stores a computer program executable on the processor, and the processor is configured to execute the computer program to:
control the transceiver to receive, on N carriers, information sent by a terminal device, N being an integer equal to or greater than 2;
control the transceiver to send first switching information to the terminal device, wherein the first switching information is used by the terminal device to determine M carriers, at least one of the M carriers is different from any one of the N carriers, and M is an integer equal to or greater than 1; and
control the transceiver to receive, on the M carriers, information sent by the terminal device.

18. The network device of claim 17, wherein the N is 2, and the N carriers comprise a first carrier and a second carrier, the first switching information indicates one of:
switching the first carrier to a third carrier;
switching the second carrier to a fourth carrier; or
switching the first carrier to the third carrier, and switching the second carrier to the fourth carrier.

19. The network device of claim 18, wherein the processor is configured to execute the computer program to:
determine a number of transmission links corresponding to the third carrier; or
determine a number of transmission links corresponding to the fourth carrier.

20. The network device of claim 18, wherein a number of transmission links corresponding to the third carrier is the same as a number of transmission links corresponding to the first carrier; and/or
a number of transmission links corresponding to the fourth carrier is the same as a number of transmission links corresponding to the second carrier.
